(19) United States
(12) Patent Application Publication
(10) Pub. No.: US 2016/0229720 A1
(43) Pub. Date: Aug. 11, 2016

(54) DEVICES AND METHODS FOR WATER DESALINATION

(71) Applicants: OKEANOS TECHNOLOGIES, LLC, Union, KY (US); BOARD OF REGENTS, THE UNIVERSITY OF TEXAS SYSTEM, Austin, TX (US)

(72) Inventors: Phillip Jordan SCHULTZ, Erlanger, KY (US); Alexander Jacob SCHULTZ, Independence, KY (US); Michael Charles BROTHERS, Union, KY (US); Tony Nick FRUDAKIS, Bradenton, FL (US); Richard M. CROOKS, College Station, TX (US); Kyle N. KNUST, Austin, TX (US)

(21) Appl. No.: 15/021,851

(22) PCT Filed: Sep. 11, 2014
(86) PCT No.: PCT/US14/55192

§ 371 Date: Mar. 14, 2016

Related U.S. Application Data
(60) Provisional application No. 61/877,912, filed on Sep. 13, 2013.

(51) Int. Cl. C02F 1/469; B01D 61/42; C02F 1/46

(52) U.S. Cl. CPC C02F 1/4698; C02F 1/4604; B01D 61/427; C02F 2103/08

(57) ABSTRACT

Devices, modules, systems, and methods for the desalination of water provided. The devices, modules, systems can include a desalination member separating a concentrated fluid chamber from a dilute fluid chamber. The desalination member can comprise one or more pores extending through the desalination member to fluidly connect concentrated fluid chamber and the dilute fluid chamber, and one or more electrodes configured to generate an electric field gradient in proximity to the opening of the one or more pores in the desalination member. Under an applied bias and in the presence of a pressure driven flow of saltwater into the concentrated fluid chamber, the electric field gradient can preferentially direct ions in saltwater away from the opening of the one or more pores in the desalination member, while desalted water can flow through the pores into dilute fluid chamber.

### TECHNICAL FIELD

This application relates generally to devices, modules, systems, and methods for the desalination of water.

### BACKGROUND

The global demand for freshwater is growing rapidly. Many conventional sources of freshwater, including lakes, rivers, and aquifers, are rapidly becoming depleted. As a consequence, freshwater is becoming a limited resource in many regions. In fact, the United Nations estimates two-thirds of the world's population could be living in water stressed regions by 2025.

Currently, approximately 97% of the world's water supply is present as seawater. Desalination—the process by which salinated water (e.g., seawater) is converted to fresh water—offers the potential to provide dependable supplies of freshwater suitable for human consumption or irrigation. Unfortunately, existing desalination processes, including distillation and reverse osmosis, require both large amounts of energy and specialized, expensive infrastructure. As a consequence, desalination is currently expensive compared to most conventional sources of water, and often prohibitively expensive in developing regions of the world. Therefore, only a small fraction of total human water use is currently satisfied by desalination. More energy efficient methods for water desalination offer the potential to address the increasing demands for freshwater, particularly in water stressed regions.

### SUMMARY

Provided are devices for the desalination of water. Devices for the desalination of water can comprise a desalination member having a top surface and a bottom surface, a concentrated fluid chamber positioned in fluid contact with the top surface of the desalination member, a dilute fluid chamber positioned in fluid contact with the bottom surface of the desalination member, and one or more pores extending through the desalination member from an opening on the top surface of the desalination member to an opening on the bottom surface of the desalination member so as to fluidly connect the concentrated fluid chamber and the dilute fluid chamber. The one or more pores can each comprise one or more pore walls which are substantially impermeable to the fluid present in the fluid chambers of the device (e.g., substantially impermeable to an aqueous solution), and which define a channel through which fluid can flow between the concentrated fluid chamber and the dilute fluid chamber.

The device can further comprise one or more electrodes in electrochemical contact with the concentrated fluid chamber, the pore(s), the dilute fluid chamber, or combinations thereof. In certain embodiments, the electrode(s) are in electrochemical contact with the pore(s). In some embodiments, the desalination member can comprise a multilayer structure. The multilayer structure can include one or more conductive layers, and a plurality of insulating layers. In these cases, the one or more conductive layers can be disposed between the plurality of insulating layers. For example, in some embodiments, the desalination member can comprise a conductive core layer having a top surface and a bottom surface, a first insulating layer disposed on the top surface of the conductive layer so as to form the top surface of the desalination member, and a second insulating layer disposed on the bottom surface of the conductive layer so as to form the bottom surface of the desalination member. The one or more pores in such devices can comprise one or more pore walls formed from the first insulating layer, the second insulating layer, and conductive core layer. In these embodiments, the conductive core layer can be in electrochemical contact with the interior of the one or more pores in the device, and thus function as the electrode(s) in electrochemical contact with the pore(s).

The one or more electrodes in the device can be configured to generate an electric field gradient in proximity to the opening of the one or more pores on the top surface of the desalination member. Under an applied bias and in the presence of pressure driven flow of saltwater from the concentrated fluid chamber to the dilute fluid chamber, the electric field gradient(s) can preferentially direct ions in the saltwater away from the opening of the pore(s) on the top surface of the desalination member allowing desalted water to flow into the dilute fluid chamber. The device can further include a second electrode (e.g., a counter electrode) positioned in proximity to the top surface of the desalination member, and configured to direct ion movement away from the opening of the pore(s) on the top surface of the desalination member.

A plurality of the devices described herein can be combined to form a water purification module. The module can comprise a plurality of the devices described herein arranged in parallel or fluidly connected in series. Modules can also comprise a plurality of devices both arranged in parallel and fluidly connected in series. For example, the module can include a first pair of devices fluidly connected in series which are arranged in parallel with a second pair of devices fluidly connected in series. One or more modules can be fluidly connected with other components (e.g., pumps, a power source, pre-filers, meters (e.g., to monitor the quality of product water), device to remove organic contaminants, and combinations thereof) to form water purification systems.

Also provided are methods of using the devices, modules, and water purification systems described herein to decrease the salinity of water.

### DESCRIPTION OF DRAWINGS

FIG. 1 is a schematic diagram of a device for the desalination of water.

FIG. 2 is an enlargement of a portion of the device illustrated in FIG. 1.

FIG. 3 is a schematic diagram of a device for the desalination of water comprising a plurality of pores.

FIG. 4 is a schematic diagram for a microfluidic two-electrode orthogonal channel device for the desalination of water.

FIGS. 5A and 5B are fluorescence micrographs illustrating the flow of a solution of a fluorescent tracer in seawater through a microfluidic two-electrode orthogonal channel device for the desalination of water. FIG. 5A is a fluorescence micrograph of the device taken before application of a potential bias. FIG. 5B is a fluorescence micrograph of the device taken upon application of a potential bias.

FIG. 6 is a plot of fluorescence line scans corresponding to the regions in FIG. 5B outlined with white boxes. Relative to the fluorescence intensity in the inlet, FIG. 6 shows a decrease in fluorescence intensity in the dilute outlet stream and an increase in the fluorescence intensity in the brine outlet stream consistent with desalination. All fluorescence intensities are plotted as arbitrary units versus distance (μm).

FIGS. 7A and 7B are fluorescence micrographs illustrating the flow of a solution of a fluorescent tracer in seawater through a microfluidic two-electrode orthogonal channel device for the desalination of water. FIG. 7A is a fluorescence micrograph of the device taken before application of a potential bias. FIG. 7B is a fluorescence micrograph of the device taken upon application of a potential bias.

FIGS. 8A and 8B are scanning electron micrographs showing pores formed within a titanium foil desalination member.

FIG. 9 shows an exploded view of the elements used to fabricate a device for the desalination of water.

FIG. 10A shows a schematic side view of the assembled device for the desalination of water.

FIG. 10B shows a schematic side view of the assembled device for the desalination of water, including arrows indicating the flow path of fluid from the concentrated fluid outlet(s) and dilute fluid outlet.

FIGS. 11A-11B are photographs of the fully assembled device for the desalination of water.

FIG. 12 shows an exploded view of the elements used to fabricate a device for the desalination of water.

FIG. 13 is a photograph of the fully assembled device for the desalination of water illustrated in FIG. 12.

FIG. 14 shows a schematic side view of an assembled example device for the desalination of water.

FIG. 15 is a micrograph showing an array of pores formed within a titanium foil desalination member.

FIG. 16 is a series of SEM micrographs showing pores formed within a titanium foil desalination member.

FIG. 17 shows an exploded view of the elements used to fabricate the device illustrated in FIG. 14.

FIG. 18 shows photographs of the fully assembled device illustrated in FIGS. 14 and 17.

FIG. 19 is a plot showing the conductivity of water flowing from the brine outlet and the fresh outlet as a function of time (in seconds) as a 1.4-2.0 V bias was applied in a step-wise fashion over increasing flow-rates.

FIG. 20 is a plot showing the conductivity of water flowing from the brine outlet and the fresh outlet at varying applied voltages (1.4 V, 1.7 V, and 2.0 V).

FIG. 21 is a schematic diagram of the sensor test-bed setup used to evaluate the example device for the desalination of water. The sensor test-bed setup provides control of operational parameters including flow rates, recovery percentages, and power supplied. In addition, the setup provides means to measure device performance.

FIGS. 22A and 22B are photographs of the sensor test-bed setup illustrated in FIG. 21.

FIG. 23 is a plot of performance data for the device illustrated in FIGS. 14 and 17 collected using sensor test-bed setup illustrated in FIG. 21.

### DETAILED DESCRIPTION

Devices for the desalination of water are provided. Referring now to FIG. 1, devices for the desalination of water (100) can comprise a desalination member (102) having a top surface (104) and a bottom surface (106), a concentrated fluid chamber (108) positioned in fluid contact with the top surface (104) of the desalination member, a dilute fluid chamber (110) positioned in fluid contact with the bottom surface (106) of the desalination member, a pore (112) extending through the desalination member (102) from an opening on the top surface of the desalination member (114) to an opening on the bottom surface of the desalination member (116) so as to fluidly connect the concentrated fluid chamber (108) and the dilute fluid chamber (110), and an electrode (118) in electrochemical contact with the concentrated fluid chamber (108), the pore (112), the dilute fluid chamber (110), or combinations thereof. In this way, the desalination member (102) can form a partition separating the concentrated fluid chamber (108) and the dilute fluid chamber (110). In certain embodiments, the electrode (118) can be positioned in electrochemical contact with the pore (112). The electrode (118) can be configured to generate an electric field gradient in proximity to the opening of the pore on the top surface of the desalination member (114). Under an applied bias and in the presence of pressure driven flow of saltwater from the concentrated fluid chamber (108) to the dilute fluid chamber (110), the electric field gradient can preferentially direct ions in the saltwater away from the opening of the pore (112) on the top surface of the desalination member (114) allowing desalted water to flow into the dilute fluid chamber (110).

The device can further include a second electrode (120) positioned in proximity to the top surface of the desalination member (104), and configured to direct ion movement away from the opening of the pore (112) on the top surface of the desalination member (114). The device can further include other features to facilitate device function. For example, the device (100) can further comprise a concentrated fluid inlet (122), concentrated fluid reservoir (124), or combination thereof fluidly connected to the concentrated fluid chamber (108). The concentrated fluid inlet (122), concentrated fluid reservoir (124), or combination thereof can be configured to provide a supply of fluid into the concentrated fluid chamber (108) during device operation. The device (100) can further comprise a concentrated fluid outlet (126), concentrated fluid outlet reservoir (e.g., a chamber fluid chamber fluidly connected downstream of fluid outlet 126), or combination thereof fluidly connected to the concentrated fluid chamber (108). The concentrated fluid outlet (126), concentrated fluid outlet reservoir, or combination thereof can be configured to receive saltwater from the concentrated fluid chamber (108) during device operation. The device (100) can further comprise a dilute fluid outlet (128), dilute fluid reservoir (e.g., a chamber fluid chamber fluidly connected downstream of dilute fluid outlet 128), or combination thereof fluidly connected to the dilute fluid chamber (110). The dilute fluid outlet (128), dilute fluid reservoir, or combination thereof can be configured to receive product water (e.g., water having a reduced salinity) from the dilute fluid chamber (110) during device operation.

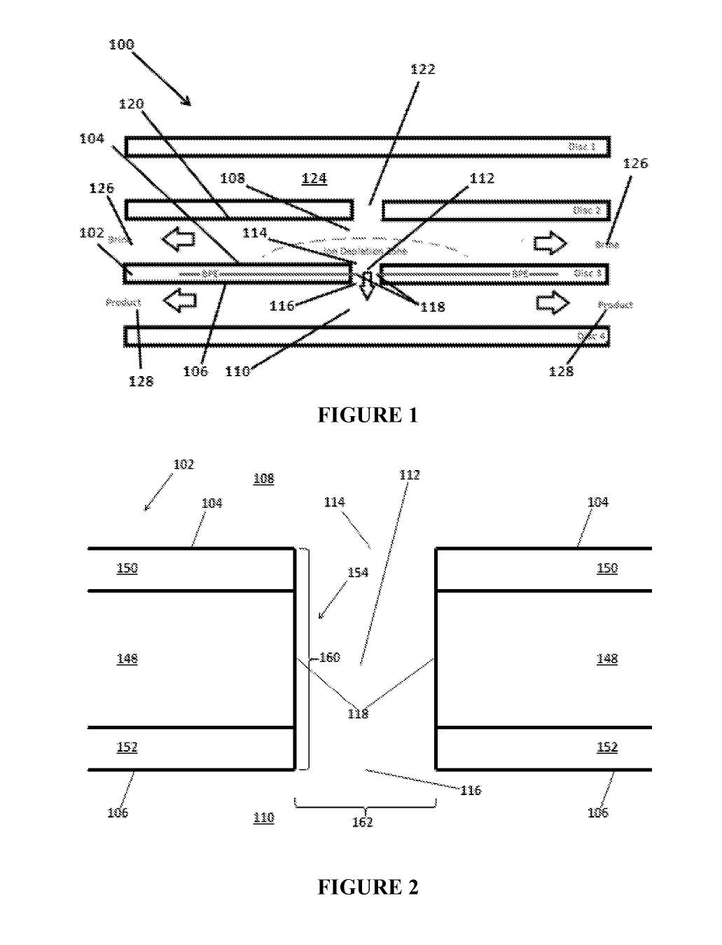

FIG. 2 shows an enlargement of the device in FIG. 1. As shown in FIG. 2, in some embodiments, the desalination member (102) can comprise a multilayer structure. The multilayer structure can include one or more conductive layers, and a plurality of insulating layers. In these cases, the one or more conductive layers can be disposed between the plurality of insulating layers, such that insulating layers form the top surface of the desalination member (104) and the bottom surface of the desalination member (106). For example, in some embodiments, the desalination member (102) can comprise a conductive core layer (148) having a top surface and a bottom surface, a first insulating layer (150) disposed on the top surface of the conductive layer (148) so as to form the top surface of the desalination member (104), and a second insulating layer (152) disposed on the bottom surface of the conductive layer (148) so as to form the bottom surface of the desalination member (106). The pore (112) can extend through the desalination member (102) from an opening on the top surface of the desalination member (114) to an opening on the bottom surface of the desalination member (116) so as to fluidly connect the concentrated fluid chamber (108) and the dilute fluid chamber (110).

Referring still to FIG. 2, the pore (112) can comprise one or more pore walls (154) which are substantially impermeable to the fluid present in the fluid chambers of the device (e.g., substantially impermeable to an aqueous solution), and which define a channel through which fluid can flow between the concentrated fluid chamber (108) and the dilute fluid chamber (110). In some cases, the pore (112) can form a channel through which fluid can flow between the concentrated fluid chamber (108) and the dilute fluid chamber (110) which is fluidly isolated from any alternative fluid flow paths between the concentrated fluid chamber (108) and the dilute fluid chamber (110) in the device (e.g., the pore can be fluidly isolated from any other pores extending through the desalination member). In certain embodiments, the pore wall (154) is formed from the first insulating layer (150), the second insulating layer (152), and conductive core layer (148). In these embodiments, the conductive core layer (148) can be in electrochemical contact with the pore (112), and thus function as the electrode (118).

The structure, dimensions, and composition of many of the features of the devices described above can be varied in view of a number of factors, including the size and position of the electrode relative to the pore, pore size, shape, number and distribution, the desired device flow rate, pH and salinity of the saltwater being treated using the device, and the desired degree of salinity reduction.

Referring again to FIG. 2, the thickness of the desalination member (160), measured as the distance from the top surface of the desalination member (104) to the bottom surface of the desalination member (106), can be varied so as to afford a pore (112) of varying lengths. In some embodiments, the desalination member (102) can have a thickness of greater than about 20 microns (e.g., greater than about 25 microns, greater than about 50 microns, greater than about 75 microns, greater than about 100 microns, greater than about 125 microns, greater than about 150 microns, greater than about 175 microns, greater than about 200 microns, greater than bout 250 microns, greater than about 300 microns, greater than about 350 microns, greater than about 400 microns, greater than about 450 microns, greater than about 500 microns, greater than about 550 microns, greater than about 600 microns, greater than about 650 microns, greater than about 700 microns, greater than about 750 microns, greater than about 800 microns, greater than about 850 microns, greater than about 900 microns, greater than about 950 microns, greater than about 1 mm, greater than about 1.25 mm, greater than about 1.5 mm, greater than about 1.75 mm, greater than about 2 mm, greater than about 2.25 mm, greater than about 2.5 mm, greater than about 2.75 mm, greater than about 3 mm, greater than about 3.25 mm, greater than about 3.5 mm, greater than about 3.75 mm, greater than about 4 mm, greater than about 4.25 mm, greater than about 4.5 mm, or greater than about 4.75 mm). In some embodiments, the desalination member (102) can have a thickness of about 5 mm or less (e.g., about 4.75 mm or less, about 4.5 mm or less, about 4.25 mm or less, about 4 mm or less, about 3.75 mm or less, about 3.5 mm or less, about 3.25 mm or less, about 3 mm or less, about 2.75 mm or less, about 2.5 mm or less, about 2.25 mm or less, about 2 mm or less, about 1.75 mm or less, about 1.5 mm or less, about 1.25 mm or less, about 1 mm or less, about 950 microns or less, about 900 microns or less, about 850 microns or less, about 800 microns or less, about 750 microns or less, about 700 microns or less, about 650 microns or less, about 600 microns or less, about 550 microns or less, about 500 microns or less, about 450 microns or less, about 400 microns or less, about 350 microns or less, about 300 microns or less, about 250 microns or less, about 200 microns or less, about 175 microns or less, about 150 microns or less, about 125 microns or less, about 100 microns or less, about 75 microns or less, about 50 microns or less, or about 25 microns or less).

The desalination member (102) can have a thickness ranging from any of the minimum values described above to any of the maximum values described above. For example, the desalination member (102) can have a thickness ranging from about 20 microns to about 5 mm (e.g., from about 20 microns to about 2.5 mm, from about 25 microns to about 2 mm, from about 50 microns to about 1 mm, or from about 100 microns to about 800 microns).

The desalination member can be formed from a variety of materials, as described in more detail below. For example, in some embodiments, the desalination member can comprise a conductive metal foil having a top surface and a bottom surface, and optionally an insulator (e.g., a polymer or insulating metal oxide) disposed on the top and/or bottom surface of the metal foil.

In some embodiments, the desalination member can comprise a conductive metal foil having a top surface and a bottom surface. In some embodiments, the desalination member can comprise a conductive metal foil having a top surface and a bottom surface, and insulator (e.g., a polymer or insulating metal oxide) disposed on the top surface of the metal foil. In some embodiments, the desalination member can comprise a conductive metal foil having a top surface and a bottom surface, and insulator (e.g., a polymer or insulating metal oxide) disposed on the bottom surface of the metal foil.

In certain embodiments, the desalination member can comprise a conductive metal foil having a top surface and a bottom surface, and an insulator (e.g., a polymer or insulating metal oxide) disposed on the top and bottom surface of the metal foil. In certain embodiments, as described in more detail below, the desalination member can comprise a titanium metal foil with a titanium oxide layer disposed on the top and bottom surface of the titanium foil. In some embodiments, the insulating layers (e.g., titanium oxide layers) can have a thickness of less than about 15 microns (e.g., less than about 10 microns, less than about 5 microns, or less).

As described above, at least one pore can extend through the desalination member. The pore can be fabricated to have any suitable cross-sectional shape. For example, the pore can have a circular, ovoid, triangular, polygonal, square, slit, rhomboid, or rectangular shape. In certain embodiments, the pore can have a substantially circular horizontal cross-section. Referring again to FIG. 2, the largest cross-sectional dimension of the pore (162; e.g., the diameter of the pore in the case of pore having a substantially circular horizontal cross-section) can be varied in view of a number of factors, including the size and position of the electrode relative to the pores, the desired device flow rate, salinity of the saltwater being treated using the device, pH or temperature of the seawater being treated using the device, and the desired degree of salinity reduction. In some embodiments, the largest cross-sectional dimension of the pore (162; e.g., the diameter of the pore in the case of pore having a substantially circular horizontal cross-section) can be greater than about 5 microns (e.g., greater than about 10 microns, greater than about 15 microns, greater than about 20 microns, greater than about 25 microns, greater than about 30 microns, greater than about 40 microns, greater than about 50 microns, greater than about 75 microns, greater than about 100 microns, greater than about 125 microns, greater than about 150 microns, greater than about 175 microns, greater than about 200 microns, greater than about 250 microns, greater than about 300 microns, greater than about 350 microns, greater than about 400 microns, greater than about 450 microns, greater than about 500 microns, greater than about 550 microns, greater than about 600 microns, greater than about 650 microns, greater than about 700 microns, greater than about 750 microns, greater than about 800 microns, greater than about 850 microns, greater than about 900 microns, greater than about 950 microns, greater than about 1 mm, greater than about 1.25 mm, greater than about 1.5 mm, greater than about 1.75 mm, greater than about 2 mm, greater than about 2.25 mm, greater than about 2.5 mm, greater than about 2.75 mm, greater than about 3 mm, greater than about 3.25 mm, greater than about 3.5 mm, greater than about 3.75 mm, greater than about 4 mm, greater than about 4.25 mm, greater than about 4.5 mm, or greater than about 4.75 mm). In some embodiments, the largest cross-sectional dimension of the pore (162; e.g., the diameter of the pore in the case of pore having a substantially circular horizontal cross-section) can be about 5 mm or less (e.g., about 4.75 mm or less, about 4.5 mm or less, about 4.25 mm or less, about 4 mm or less, about 3.75 mm or less, about 3.5 mm or less, about 3.25 mm or less, about 3 mm or less, about 2.75 mm or less, about 2.5 mm or less, about 2.25 mm or less, about 2 mm or less, about 1.75 mm or less, about 1.5 mm or less, about 1.25 mm or less, about 1 mm or less, about 950 microns or less, about 900 microns or less, about 850 microns or less, about 800 microns or less, about 750 microns or less, about 700 microns or less, about 650 microns or less, about 600 microns or less, about 550 microns or less, about 500 microns or less, about 450 microns or less, about 400 microns or less, about 350 microns or less, about 300 microns or less, about 250 microns or less, about 200 microns or less, about 175 microns or less, about 150 microns or less, about 125 microns or less, about 100 microns or less, about 75 microns or less, about 50 microns or less, about 40 microns or less, about 30 micron or less, about 25 microns or less, about 20 microns or less, about 15 microns or less, or about 10 microns or less).

The largest cross-sectional dimension of the pore (162; e.g., the diameter of the pore in the case of pore having a substantially circular horizontal cross-section) can range from any of the minimum values described above to any of the maximum values described above. For example, the largest cross-sectional dimension of the pore (162; e.g., the diameter of the pore in the case of pore having a substantially circular horizontal cross-section) can range from about 5 microns to about 5 mm (e.g., from about 20 microns to about 5 mm, from about 20 microns to about 1.5 mm, from about 50 microns to about 1 mm, from about 5 microns to about lmm, from about 50 microns to about 500 microns, from about 5 microns to about 500 microns, from about 100 microns to about 1 mm, from about 100 microns to about 750 microns, from about 5 microns to about 750 microns, from about 5 microns to about 500 microns, from about 5 microns to about 250 microns, from about 20 microns to about 75 microns, from about or from about 100 microns to about 500 microns).

The pore can be formed within the desalination member using a variety of suitable methods, including plasma etching and laser ablation. An appropriate method for pore formation can be selected in view of a number of factors, including the desired dimensions of the pore and the thickness and composition of the desalination member. One pore can function in isolation. Alternatively, a plurality of pores (e.g., 10, 100, 1000, 10,000, 100,000 or 1,000,000, or more pores) can function together in an array for desalination. In these cases, the plurality of pores can be arranged in any suitable configuration, so as to form an array of any desired shape. For example, the plurality of pores can be arranged to form a circular, square, or rectangular (X by Y pores, where both X and Y are integers) array.

The electrode (118) in the device can be fabricated from any suitable conductive material, such as a metal (e.g., gold, platinum, or titanium), metal alloy, metal oxide, or conductive carbon. In some cases, the electrode can further comprise a catalyst coating in contact with the fluid medium. The catalyst coating can comprise, for example, iridium, ruthenium, platinum, tin, or combinations thereof (e.g., a 1:5 mixture of iridium:ruthenium). The electrode (118) can be configured so as to be in electrochemical contact with the concentrated fluid chamber (108), the pore (112), the dilute fluid chamber (110), or combinations thereof, so as to generate an electric field gradient in proximity to the opening of the pore on the top surface of the desalination member (114). By electrochemical contact, it is meant that the electrode (118) can participate in a faradaic reaction with one or more components of a solution present in the concentrated fluid chamber (108), the pore (112), the dilute fluid chamber (110), or combinations thereof. For example, the electrode (118) can be configured such that a surface of the electrode is in direct contact with fluid present in the concentrated fluid chamber (108), the pore (112), the dilute fluid chamber (110), or combinations thereof. More than one electrode may be in electrochemical contact with the concentrated fluid chamber (108), the pore (112), the dilute fluid chamber (110), or combinations thereof, if desired for device design.

The device can be configured such that the electrode (118) can function as either an anode, cathode, or anode and cathode during device operation. During the device operation, the electrode can be energized with a voltage potential against either another body of water (e.g., an auxiliary channel as discussed below) or a ground. In certain embodiments, the device can be configured such that the electrode (118) functions as an anode during device operation, resulting in oxidation of chloride at or near the surface of electrode 118. Oxidation of chloride at the electrode (118) results in formation of an ion depletion zone and subsequent electric field gradient in proximity to the opening of the pore (112) on the top surface of the desalination member (114). Under an applied bias and in the presence of pressure driven flow of saltwater from the concentrated fluid chamber (108) to the dilute fluid chamber (110), the electric field gradient can preferentially direct ions in the saltwater away from the opening of the pore (112) on the top surface of the desalination member (114) allowing desalted water to flow into the dilute fluid chamber (110). In some embodiments, such as in the case of reverse polarity, the electrode can serve as the cathode. Reverse polarity can be used to eliminate scale that can build up on the electrode surface during the course of device function.

In some embodiments, the electrode (118) can be configured to generate an ion depletion zone and subsequent electric field gradient which are complementary in shape to the cross-sectional shape of the pore (112). In this way, the electric field gradient formed by the electrode (118) can efficiently direct ions in the saltwater away from the opening of the pore (112) on the top surface of the desalination member (114). By way of example, the pore (112) can be radially symmetrical about a central axis (e.g., the pore can have a substantially circular horizontal cross-section). In these embodiments, the electrode (118) can also be configured to be radially symmetrical about the central axis, so as to form an ion depletion zone and subsequent electric field gradient which are radially symmetrical about the central axis.

In certain embodiments, the electrode (118) is in electrochemical contact with the pore (112). Referring again to FIG. 2, the electrode (118) can form at least a portion of the pore wall(s) (154). The amount of the pore wall formed by the electrode can vary based on a number of factors. For example, the electrode can form at least 10% of the pore wall, based on the total surface area of the pore wall (e.g., at least 20% of the pore wall, at least 30% of the pore wall, at least 40% of the pore wall, at least 50% of the pore wall, at least 60% of the pore wall, at least 70% of the pore wall, at least 80% of the pore wall, or at least 90% of the pore wall). In certain embodiments, the electrode (118) can be configured to be radially symmetrical about the central axis of the pore. For example in the case of a pore having a substantially circular horizontal cross-section, the electrode can be a continuous band or region disposed around the circumference of the pore wall.

In certain embodiments, the electrode (118) can be formed so as to be resistant to corrosion (e.g., chlorine oxidation in the case of desalination). For example, in some cases, the electrode can be a metal electrode (e.g., a titanium electrode) comprising an anti-corrosive coating (e.g., a metal oxide or mixed metal oxide coating, such as an iridium oxide coating, a ruthenium oxide coating, tantalum oxide coating, or combinations thereof) and/or a catalytic coating (e.g. iridum:ruthenium, ruthenium, iridium, platinum, tantalum, iridium-tantalum, or other metal or mixed metal oxide). For example, in certain embodiments, the electrode can comprise a titanium electrode comprising an iridium-tantalum oxide mixed metal oxide coating. In certain embodiments, an anti-corrosive coating can cover the top/bottom surfaces of the electrode, and a catalytic coating can cover the interior surfaces of the electrode (e.g., the pore wall in contact with fluid traversing through the pore).

In certain embodiments, the device comprises an electrode that is resistant to corrosion during device operation for a period of at least about one month (e.g., at least about six months, at least about one year, or at least about five years). The electrode can be said to be resistant to corrosion during device operation for a given period of time when the surface area of the electrode remains substantially unchanged (e.g., changes less than 10%, changes less than 5%, changes less than 3%, or changes less than 1%) upon application of a 3V potential bias and flow of a 0.5 M aqueous NaCl at 20 degrees Celsius through the device.

The electrode (118) can be a pole of a bipolar electrode. In these embodiments, the device (100) can further comprise an auxiliary fluid channel. The auxiliary fluid channel can be a fluid channel or chamber which is fluidly isolated from the concentrated fluid chamber, the pore, and the dilute fluid chamber. The electrode can comprise a bipolar electrode electrochemically connecting the concentrated fluid chamber, the pore, the dilute fluid chamber, or combinations thereof to the auxiliary channel.

The device can further include a second electrode (120) (e.g., a counter electrode or a ground) positioned in proximity to the top surface of the desalination member (104), and configured to direct ion movement away from the opening of the pore (112) on the top surface of the desalination member (114). The second electrode can be configured to operate as an anode, cathode, or anode and cathode during device operation, depending upon the nature of the reaction performed at electrode 118. In certain embodiments, electrode 118 is configured to function as an anode during device operation, and the second electrode 120 is configured to function as a cathode. In some embodiments, the second electrode can be positioned less than about 1 mm from the top surface of the desalination member (104) (e.g., less than about 900 microns, less than about 800 microns, less than about 700 microns, less than about 600 microns, less than about 500 microns, less than about 400 microns, less than about 300 microns, less than about 200 microns, or less than about 100 microns). In other embodiments, the second electrode can be positioned 1 mm or more from the top surface of the desalination member (104) (e.g., at least about 1.25 mm, at least about 1.5 mm, at least about 1.75 mm, at least about 2 mm, at least about 2.5 mm, or more). A spacer material can be used to ensure fixed separation between the top surface of the desalination member (104) and the second electrode (120). The second electrode can be fabricated from any suitable conductive material, such as a metal (e.g., gold, platinum, or titanium), metal alloy, metal oxide, or conductive carbon. In one embodiment, the second electrode is fabricated from boron-doped diamond.

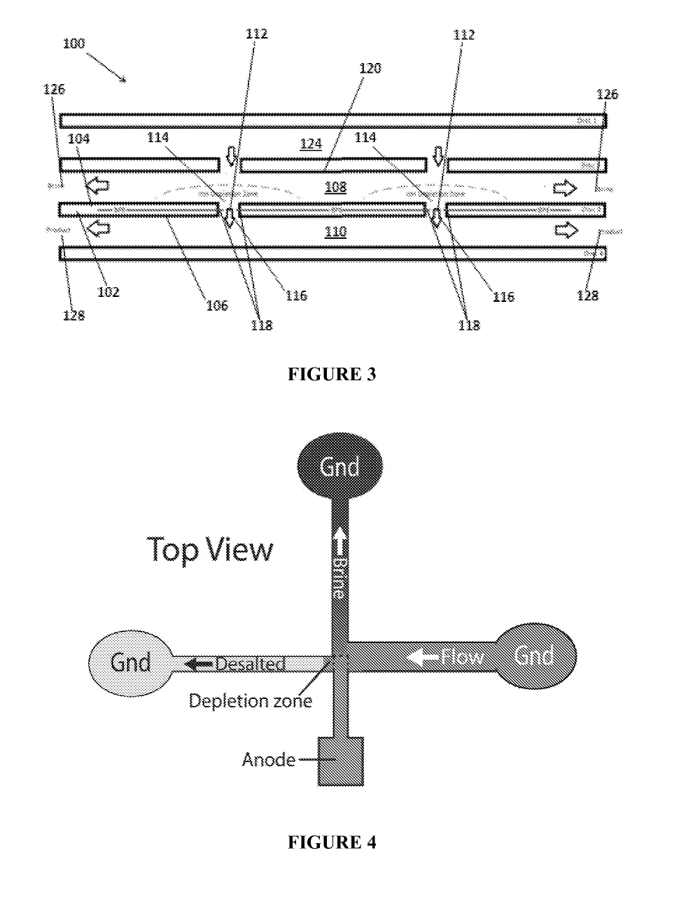

Referring now to FIG. 3, in some embodiments, the device (100) can include a plurality of pores (112), each of which extends through the desalination member (102) from an opening on the top surface of the desalination member (114) to an opening on the bottom surface of the desalination member so as to fluidly connect the concentrated fluid chamber (108) and the dilute fluid chamber (110). In these embodiments, an electrode (118) can be positioned in electrochemical contact with the concentrated fluid chamber (108), the pore (112), the dilute fluid chamber (110), or combinations thereof, so as to generate an electric field gradient in proximity to the opening of each pore on the top surface of the desalination member (114). In some embodiments, the desalination member can comprise a mesh or screen containing a plurality of pores.

In these embodiments, the device (118) can comprises a plurality of electrodes (118), each of which are electrically independent, but which in combination are configured to generate an electric field gradient in proximity to the opening of each of the plurality of pores on the top surface of the desalination member (114). For example, the device can comprise an individual electrode configured to generate an electric field gradient in proximity to the opening of each individual pore on the top surface of the desalination member. If desired, the plurality of electrodes can be electrically connected to an individual power source, such that they can be energized in combination. In other embodiments, the device (100) can comprise a single electrode (118) which is configured to generate an electric field gradient in proximity to the opening of each of the plurality of pores on the top surface of the desalination member (114). For example, the desalination member (102) can comprise a multilayer structure including one or more conductive layers, and a plurality of insulating layers, as described above. The conductive layer can form at least a portion of the pore wall of each of the pores in the device, such that the conductive layer can function as the electrode (118), and be configured to generate an electric field gradient in proximity to the opening of each of the plurality of pores on the top surface of the desalination member (114).

The device can comprise any number of pores extending through the desalination member from an opening on the top surface of the desalination member to an opening on the bottom surface of the desalination member so as to fluidly connect the concentrated fluid chamber and the dilute fluid chamber. The number of pores in the device can be selected in view of a number of factors, including the desired output of the device, the dimensions of the pores in the device, considerations regarding device size, and considerations regarding device fabrication. In some embodiments, the device can comprise at least about 500 pores (e.g., at least about 1,000 pores, at least about 5,000 pores, at least about 50,000 pores, at least about 100,000 pores, at least about 250,000 pores, at least about 500,000 pores, at least about 750,000 pores, at least about 1 million pores, at least about 1.25 million pores, at least about 1.5 million pores, at least about 1.75 million pores, at least about 2 million pores, at least about 2.25 million pores, at least about 2.5 million pores, at least about 2.75 million pores, at least about 3 million pores, at least about 3.25 million pores, at least about 3.5 million pores, at least about 3.75 million pores, at least about 4 million pores, at least about 4.25 million pores, at least about 4.5 million pores, at least about 4.75 million pores, at least about 5 million pores, at least about 6 million pores, at least about 7 million pores, at least about 8 million pores, or at least about 9 million pores). In some embodiments, the device can comprise about 10 million pores or less (e.g., about 9 million pores or less, about 8 million pores or less, about 7 million pores or less, about 6 million pores or less, about 5 million pores or less, about 4.75 million pores or less, about 4.5 million pores or less, about 4.25 million pores or less, about 4 million pores or less, about 3.75 million pores or less, about 3.5 million pores or less, about 3.25 million pores or less, about 3 million pores or less, about 2.75 million pores or less, about 2.5 million pores or less, about 2.25 million pores or less, about 2 million pores or less, about 1.75 million pores or less, about 1.5 million pores or less, about 1.25 million pores or less, about 1 million pores or less, about 750,000 pores or less, about 500,000 pores or less, about 250,000 pores or less, about 100,000 pores or less, about 50,000 pores or less, about 5,000 pores or less, or about 1,000 pores or less). In some embodiments, the device can comprise a number higher than the maximum values described above. For example, the device can comprise from about 5 million pores to 1 billion pores, or 10 billion pores, or 100 billion pores, or even more.

The device can comprise a number ranging from any of the minimum values described above to any of the maximum values described above. For example, the device can comprise from about 500 pores to about 10 million pores (e.g., from about 5,000 pores to about 10 million pores, from about 500 pores to about 5 million pores, from about 5,000 pores to about 5 million pores, from about 500,000 pores to about 5 million pores, or from about 500,000 pores to about 2 million pores).

The density of the pores within the desalination member (i.e., the “pore density,” the number of pores within the desalination member per cm² of the top surface of the desalination member) can also be varied in view of a number of factors, including the desired output of the device, the dimensions of the pores in the device, considerations regarding device size, device durability and/or pressure tolerance, and considerations regarding device fabrication. In some embodiments, the device comprises a pore density of at least about 100 pores per cm² of desalination member (e.g., at least about 500 pores per cm² of desalination member, at least about 1,000 pores per cm² of desalination member, at least about 2,000 pores per cm², at least about 3,000 pores per cm², at least about 3,000 pores per cm², at least about 3,000 pores per cm², at least about 4,000 pores per cm², at least about 5,000 pores per cm², at least about 6,000 pores per cm², at least about 7,000 pores per cm², at least about 8,000 pores per cm², at least about 9,000 pores per cm², at least about 10,000 pores per cm², at least about 11,000 pores per cm², at least about 12,000 pores per cm², at least about 13,000 pores per cm², at least about 14,000 pores per cm², at least about 15,000 pores per cm², at least about 20,000 pores per cm², at least about 25,000 pores per cm², or at least about 30,000 pores per cm²). In some embodiments, the device comprises a pore density of about 35,000 pores per cm² of desalination member or less (e.g., about 30,000 pores per cm² of desalination member or less, about 25,000 pores per cm² of desalination member or less, about 20,000 pores per cm² of desalination member or less, about 15,000 pores per cm² of desalination member or less, about 14,000 pores per cm² or less, about 13,000 pores per cm² or less, about 12,000 pores per cm² or less, about 11,000 pores per cm² or less, about 10,000 pores per cm² or less, about 9,000 pores per cm² or less, about 8,000 pores per cm² or less, about 7,000 pores per cm² or less, about 6,000 pores per cm² or less, about 5,000 pores per cm² or less, about 4,000 pores per cm² or less, about 3,000 pores per cm² or less, about 2,000 pores per cm² or less, about 1,000 pores per cm² or less, or about 500 pores per cm² or less).

The device can comprise a pore density ranging from any of the minimum values described above to any of the maximum values described above. For example, the device can comprise a pore density of from about 100 pores per cm² of desalination member to about 35,000 pores per cm² of desalination member (e.g., from about 100 pores per cm² of desalination member to about 15,000 pores per cm² of desalination member, from about 100 pores per cm² of desalination member to about 15,000 pores per cm² of desalination member, from about 1,000 pores per cm² of desalination member to about 10,000 pores per cm² of desalination member, from about 1,000 pores per cm² of desalination member to about 5,000 pores per cm² of desalination member, or from about 15,000 pores per cm² of desalination member to about 35,000 pores per cm² of desalination member).

To facilitate device use, the device described above can be enclosed within a housing. The housing can control fluid flow over the array of pores, such that a balance between salinity and hydraulic pressure is reached for all pores of the array. For example, in one embodiment, the interior surface of the housing opposite the electrode may or may not support the cathode, and may or may not be sloped at an angle relative to the electrode in order to create a nozzle effect such that hydraulic pressure is held constant throughout the interior space above the array. Hydraulic drops as a function of distance from the fluid input, and such a nozzle effect would mitigate this drop. The cathode may or may not serve as the upper surface of this nozzle, and may or may not contain pores or holes as a means by which to balance and control flow dynamics.

The housing can include one or more fluid connections and one or more electrical connections to facilitate device use. The devices described above can further include a power supply electrically connected to the electrode or the plurality of electrodes. The power supply can be directly electrically connected to the electrode or plurality electrodes, or indirectly electrically connected through a transduction media, such as water in an auxiliary channel. The power supply can be configured to apply an appropriate potential to achieve device function. For example, the power supply can be configured to apply a potential bias at the electrode of greater than about 1 volt to generate an electric field gradient (e.g., greater than about 2 volts, greater than about 2.5 volts, greater than about 3 volts, greater than about 4 volts, greater than about 5 volts, greater than about 6 volts, greater than about 7 volts, greater than about 8 volts, or greater than about 9 volts). In some embodiments, the power supply can be configured to apply a potential bias at the electrode of less than about 10 volts to generate an electric field gradient (e.g., less than about 9 volts, less than about 9 volts, less than about 8 volts, less than about 7 volts, less than about 6 volts, less than about 5 volts, less than about 4 volts, less than about 3 volts, less than about 2.5 volts, or less than about 2 volts).

The power supply can be configured to apply a potential bias at the electrode ranging from any of the minimum voltages described above to any of the maximum voltages described above. For example, the power supply can be configured to apply a potential bias at the electrode ranging from about 1 volt to about 10 volts (e.g., from about 1 volt to about 7 volts, from about 2 volts to about 7 volts, or from about 2.5 to about 5 volts). In certain embodiments, the power supply can be configured to apply a potential bias at the electrode of approximately 3 volts.

The devices described herein can further include one or more additional components (e.g., pressure gauges, valves, pressure inlets, pumps, fluid reservoirs, sensors, electrodes, power supplies, and combinations thereof) to facilitate device function. In some embodiments, the devices include a pump, valve, fluid reservoir, or combination thereof configured to regulate fluid flow into the concentrated fluid inlet(s) of the device. The device can be configured to desalinate water under pressure driven flow of saltwater through the device. Thus, in some embodiments, the device includes a pump configured to provide for pressure driven flow of a fluid through the device. In certain embodiments, the device is configured such that there is a measurable pressure drop (e.g., at least 1%, or at least 5%) across the desalination member during device operation.

The devices can include a salinometer configured to measure the salinity of fluid flowing through one or more of the concentrated fluid inlets, concentrated fluid outlets and/or dilute fluid outlets of the device. For example, in some cases, the devices can include a salinometer configured to measure the salinity of fluid flowing through the dilute fluid outlets of the device to monitor the salinity of fluid following treatment with the device. The salinometer can measure the salinity of the fluid via any suitable means. For example, the salinometer can measure the fluid's electrical conductivity, specific gravity, index of refraction, or combinations thereof.

In certain embodiments, the devices can include a salinometer configured to measure the salinity of fluid flowing through the dilute fluid outlet(s), and a pump, valve, fluid reservoir, or combination thereof configured to regulate fluid flow into the concentrated fluid chamber of the device. The devices can further include signal processing circuitry or a processor configured to operate the pump and/or valve configured to regulate fluid flow into the concentrated fluid chamber of the device so as to adjust fluid flow into the concentrated fluid chamber of the device in response to the salinity of fluid flowing through the dilute fluid outlet.

A plurality of the devices described herein can be combined to form a module for the desalination of water. Modules can comprise any number of the devices described herein. The number of devices incorporated within the module can be selected in view of a number of factors, including the overall system design, the desired throughput of the system, salinity of the saltwater being treated using the system, and the desired degree of salinity reduction.

In some cases, the concentrated fluid inlet(s) of two or more of the devices in the module are fluidly connected to a common water inlet, so as to facilitate the flow of saltwater into the concentrated fluid inlet(s) of multiple devices in the module. Similarly, the dilute outlet channels of two or more of the devices in the module can be fluidly connected to a common water outlet, so as to facilitate the collection of desalted water from the dilute fluid outlets of multiple devices in the module.

The module can comprise a plurality of the devices described herein arranged in parallel. Within the context of the modules described herein, two devices can be described as being arranged in parallel within a module when fluid flowing from either the dilute fluid outlet or the concentrated fluid outlet of the first device in the module does not subsequently flow into the fluid inlet of the second device in the module.

The module can comprise a plurality of the devices described herein fluidly connected in series. Within the context of the modules described herein, two devices can be described as being fluidly connected in series within a module when fluid flowing from either the dilute fluid outlet(s) or the concentrated fluid outlet(s) of the first device in the module subsequently flows into the concentrated fluid inlet(s) of the second device in the module.

If desired, the module can contain a plurality of devices both arranged in parallel and fluidly connected in series. For example, the module can include a first pair devices fluidly connected in series which are arranged in parallel with a second pair of devices fluidly connected in series. One or more modules can be fluidly connected with other components (e.g., pumps, a power source, pre-filers, meters (e.g., to monitor the quality of product water), device to remove organic contaminants, and combinations thereof) to form a water purification system.

The devices, modules, and systems described herein can be used to decrease the salinity of water or an aqueous solution. The salinity of water can be decreased by flowing water having a first salinity through a device comprising a desalination member having a top surface and a bottom surface; a concentrated fluid chamber positioned in fluid contact with the top surface of the desalination member; a dilute fluid chamber positioned in fluid contact with the bottom surface of the desalination member; and a pore extending through the desalination member from an opening on the top surface of the desalination member to an opening on the bottom surface of the desalination member so as to fluidly connect the concentrated fluid chamber and the dilute fluid chamber; and performing a faradaic reaction at an electrode in electrochemical contact with the concentrated fluid chamber, the pore, the dilute fluid chamber, or combinations thereof to generate an electric field gradient in proximity to the opening of the pore on the top surface of the desalination member. The electric field gradient can direct ions in the water having a first salinity away from the opening of the pore on the top surface of the desalination member, allowing water having a second salinity less than the first salinity to pass through the pore and into the dilute fluid chamber. In certain embodiments, the pore can be radially symmetrical about a central axis, and the electrode can configured to generate an electric field gradient which is symmetrical (e.g., radially symmetrical) about the central axis.

In some embodiments, methods of decreasing the salinity of water can include providing a flow of water having a first salinity into the concentrated fluid chamber of a device described above or the water inlet of a module or system described above, applying a potential bias to generate an electric field gradient that influences the flow of ions through the pore or the plurality of pores of the device, module, or system, and collecting water having a second salinity from the dilute fluid chamber of the device or the water outlet of the module or system. The second salinity can be less than the first salinity.

In some embodiments, the potential bias applied to generate an electric field gradient is greater than about 1 volt (e.g., greater than about 2 volts, greater than about 2.5 volts, greater than about 3 volts, greater than about 4 volts, greater than about 5 volts, greater than about 6 volts, greater than about 7 volts, greater than about 8 volts, or greater than about 9 volts). In some embodiments, the potential bias applied to generate an electric field gradient is less than about 10 volts (e.g., less than about 9 volts, less than about 9 volts, less than about 8 volts, less than about 7 volts, less than about 6 volts, less than about 5 volts, less than about 4 volts, less than about 3 volts, less than about 2.5 volts, or less than about 2 volts).

The potential bias applied to generate an electric field gradient can range from any of the minimum voltages to any of the maximum voltages described above. In some embodiments, the potential bias applied to generate an electric field gradient ranges from about 1 volt to about 10 volts (e.g., from about 1 volt to about 7 volts, from about 2 volts to about 7 volts, or from about 2.5 to about 5 volts). In certain embodiments, the potential bias applied to generate an electric field gradient can be approximately 3 volts.

The devices, modules, systems, and methods described herein can be used to decrease the salinity of saltwater having any measurable concentration of dissolved sodium chloride. The saltwater can be seawater (e.g., saltwater having a conductivity of between about 4 S/m and about 6 S/m). The saltwater can be brackish water (e.g., saltwater having a conductivity of between about 0.05 S/m and about 4 S/m). In certain embodiments, the saltwater has a conductivity of greater than about 0.05 S/m (e.g., greater than about 0.1 S/m, greater than about 0.5 S/m, greater than about 1.0 S/m, greater than about 2.0 S/m, greater than about 2.5 S/m, greater than about 3.0 S/m, greater than about 3.5 S/m, greater than about 4.0 S/m, greater than about 4.5 S/m, greater than about 5.0 S/m, greater than about 5.5 S/m, greater than about 6.0 S/m, greater than about 6.5 S/m, greater than about 7.0 S/m, greater than about 7.5 S/m, greater than about 10 S/m, greater than about 15 S/m, or greater).

The devices, modules, systems, and methods described herein can be used to decrease the salinity of saltwater by varying degrees. The degree of salinity reduction can depend on a number of factors, including the architecture of the device, module, or system, and the salinity of the saltwater being treated using the device, module, or system.

In some embodiments, the conductivity of the water desalinated using the devices, modules, systems, and methods described herein (e.g., the water collected from the dilute fluid outlet of the device or the water outlet of the module or system) does not exceed about 90% of the conductivity of the saltwater flowed into the device, module, or system (e.g., it does not exceed about 80% of the conductivity of the saltwater flowed into the device, module, or system, it does not exceed about 75% of the conductivity of the saltwater flowed into the device, module, or system, it does not exceed about 70% of the conductivity of the saltwater flowed into the device, module, or system, it does not exceed about 60% of the conductivity of the saltwater flowed into the device, module, or system, it does not exceed about 50% of the conductivity of the saltwater flowed into the device, module, or system, it does not exceed about 40% of the conductivity of the saltwater flowed into the device, module, or system, it does not exceed about 30% of the conductivity of the saltwater flowed into the device, module, or system, it does not exceed about 25% of the conductivity of the saltwater flowed into the device, module, or system, it does not exceed about 20% of the conductivity of the saltwater flowed into the device, module, or system, it does not exceed about 10% of the conductivity of the saltwater flowed into the device, module, or system, it does not exceed about 5% of the conductivity of the saltwater flowed into the device, module, or system, it does not exceed about 1% of the conductivity of the saltwater flowed into the device, module, or system, it does not exceed about 0.5% of the conductivity of the saltwater flowed into the device, module, or system, it does not exceed about 0.1% of the conductivity of the saltwater flowed into the device, module, or system, it does not exceed about 0.05% of the conductivity of the saltwater flowed into the device, module, or system, it does not exceed about 0.01% of the conductivity of the saltwater flowed into the device, module, or system, or less).

In some cases, water desalinated using the devices, modules, systems, and methods described herein (e.g., water collected from the dilute fluid outlet of the device or the water outlet of the system) has a conductivity of less than about 3.0 S/m (e.g., less than about 2.5 S/m, less than about 2.0 S/m, less than about 1.75 S/m, less than about 1.5 S/m, less than about 1.25 S/m, less than about 1.0 S/m, less than about 0.75 S/m, less than about 0.5 S/m, less than about 0.25 S/m, less than about 0.1 S/m, less than about 0.05 S/m, less than about 0.01 S/m, less than about 0.005 S/m, less than about 0.001 S/m, less than about 5.0×10⁻⁴ S/m, less than about 1.0×10⁻⁴ S/m, less than about 5.0×10⁻⁵ S/m, less than about 1.0×10⁻⁵ S/m, or less).

In some embodiments, the water desalinated using the devices, modules, systems, and methods described herein (e.g., water collected from the dilute fluid outlet of the device or the water outlet of the system) is drinking water (e.g., the water has a conductivity of from about 0.05 S/m to about 0.005 S/m). In some embodiments, the water desalinated using the devices, modules, systems, and methods described herein (e.g., water collected from the dilute fluid outlet of the device or the water outlet of the system) is ultrapure water (e.g., the water has a conductivity of from about 0.005 S/m to about 5.5×10⁻⁶ S/m).

If desired, water can be treated multiple times using the devices, modules, systems, and methods described herein to achieve a desired decrease in the salinity of the saltwater.

The devices, modules, and systems described herein can be used to desalinate water with greater energy efficiency than conventional desalination methods. In some cases, the devices, modules, and systems described herein can be used to desalinate water with at an energy efficiency of less than about 1000 mWh/L (e.g., at least about 900 mWh/L, at least about 800 mWh/L, at least about 750 mWh/L, at least about 700 mWh/L, at least about 600 mWh/L, at least about 500 mWh/L, at least about 400 mWh/L, at least about 300 mWh/L, at least about 250 mWh/L, at least about 200 mWh/L, at least about 100 mWh/L, at least about 90 mWh/L, at least about 80 mWh/L, at least about 75 mWh/L, at least about 70 mWh/L, at least about 60 mWh/L, at least about 50 mWh/L, at least about 40 mWh/L, at least about 30 mWh/L, at least about 25 mWh/L, at least about 20 mWh/L, at least about 15 mWh/L, or at least about 10 mWh/L, or at least about 5 mWh/L). In some embodiments, the devices, modules, and systems described herein can be used to desalinate water with at an energy efficiency ranging from any of the minimum values above to about 1 mWh/L (e.g., from at least about 1000 mWh/L to about 1 mWh/L, from at least about 500 mWh/L to about 1 mWh/L, from at least about 100 mWh/L to about 1 mWh/L, from at least about 75 mWh/L to about 1 mWh/L, or from at least about 50 mWh/L to about 1 mWh/L).

In some cases, the saltwater is not pre-treated prior to desalination with the devices, modules, and systems described herein. In other embodiments, the saltwater can be treated prior to desalination. For example, the removal of multivalent cations (e.g., Ca²⁺, Mg²⁺, or combinations thereof) from saltwater prior to desalination could reduce precipitate formation within the device or system over long operation times. Accordingly, in some embodiments, the saltwater can be pre-treated to reduce the level of dissolved multivalent cations in solution, for example, by contacting the saltwater with a suitable ion exchange resin. If necessary, saltwater can also be pre-treated to remove debris, for example, by sedimentation and/or filtration. If desired, saltwater can also be disinfected prior to desalination.

If desired for a particular end use, water can be further treated following desalination with the devices, modules, and systems described herein. For example, water can be fluoridated by addition of a suitable fluoride salt, such as sodium fluoride, fluorosilicic acid, or sodium fluorosilicate. Water can also be passed through an ion exchange resin and/or treated to adjust pH following desalination with the devices and systems described herein

While desalination is discussed, it will be understood that the devices, modules, and systems described herein can be used to increase the concentration of ions in a fluid. This can be accomplished using the methods described herein, wherein the product fluid is the fluid collected from the concentrated fluid outlet. Accordingly, the devices, modules, and systems described herein can be used to increase the concentration of ions in an aqueous solution. These methods can be used to increase the concentration of metal ions in an aqueous solution, by way of example, as part of a mining, refining, or isolation process to increase the concentration of a desired metal salt in a solution, or in environmental remediation (e.g., mercury remediation, the treatment of contaminated groundwater and/or soil, etc.)

### EXAMPLES

### Example 1

### Desalination Using a Microfluidic Two-Electrode Orthogonal Channel Device

A microelectrochemical cell with an inlet channel bifurcating to two orthogonal channels with an embedded electrode at the bifurcation was used to desalinate salt water along a locally generated electric field gradient in the presence of pressure driven flow (PDF). Desalination was achieved by applying a potential bias between an electrode embedded at the channel center and outlets to drive chloride oxidation at the anode.

The oxidation of chloride at the anode embedded at the channel bifurcation results in an ion depletion zone and subsequent electric field gradient. The electric field gradient directed ions flowing through the channel inlet into a branching microchannel, creating a brine stream, while desalted water continued to flow forward when the rate of pressure driven flow was controlled. Desalination could thus be achieved by controlling the rate of pressure driven flow to create both a salted and desalted stream.

Materials and Methods

Fabrication of Microfluidic Device

A PDMS/glass hybrid microfluidic device was prepared using microfabrication methods known in the art. The structure of the microfluidic device is schematically illustrated in FIG. 4. The device comprises an inlet channel bifurcating to two orthogonal channels with an embedded electrode at the bifurcation.

A platinum (Pt) electrode was fabricated on a glass slide (1 in×1 in). Photoresist was spin coated onto the slide at 3500 rpm for 45 seconds, and then soft baked on a hot plate at 100° C. for 45 seconds to remove excess solvent. The device was then exposed to a UV lamp with patterned mask above to reveal a negative relief of the electrode (100 μm wide) design. The excess photoresist was then removed by development with 1:4 (v:v) AZ 421K. The devices were then placed in a vacuum chamber and underwent e-beam deposition of a 10 nm thick Ti adhesion layer followed by a 100 nm thick layer of Pt. After metal deposition, excess metal and photoresist was removed in an acetone bath under sonication for 5 minutes. Lastly, the devices were rinsed with acetone and then ethanol.

A PDMS desalination unit (5.0 mm long and 24 μm tall) with a 100 μm wide inlet channel and 50 μm wide dilute outlet channel and concentrated outlet channel was fabricated using a SU-8 2025 photoresist mold patterned on a silicon wafer. The PDMS channel was rinsed with ethanol and dried under N₂, then the PDMS and glass/electrode surfaces were exposed to an air plasma for 15 seconds, and finally the two parts were bound together with the electrode aligned at the intersection where the dilute outlet channel and concentrated outlet channel diverge from the inlet channel. The PDMS/glass microfluidic device was then placed in an oven at 65° C. for 5 min to promote irreversible bonding.

Evaluation of Desalination

An artificial seawater solution was used to evaluate desalination. The seawater was spiked with an anionic (10 μM 4,4-Difluoro-1,3,5,7,8-Pentamethyl-4-Bora-3a,4a-Diaza-s-Indacene-2,6-Disulfonic Acid, BODIPY²⁻) tracer to fluorescently monitor the movement of ions through the desalination unit during desalination.

A solution height differential was created between the fluid reservoir fluidly connected to the inlet channel and the fluid reservoirs fluidly connected to the concentrated outlet channel and fluidly connected to the dilute outlet channel. In this way, a pressure driven flow (PDF) from right to left was initiated.

Results

A 1.4 V bias was applied between the microfabricated Pt anode and Pt wire cathodes in the reservoirs. The potential bias created a sufficiently large potential difference between the anode and cathode to drive chloride oxidation at the anode, thus directly resulting in an ion depletion zone near the anode as chlorine was generated.

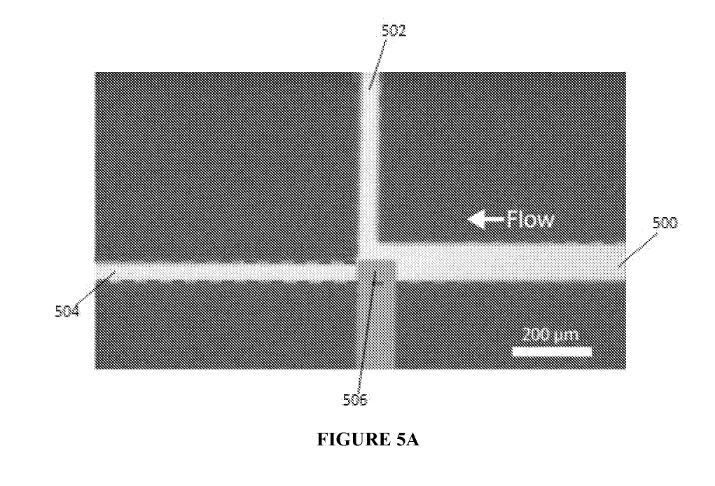

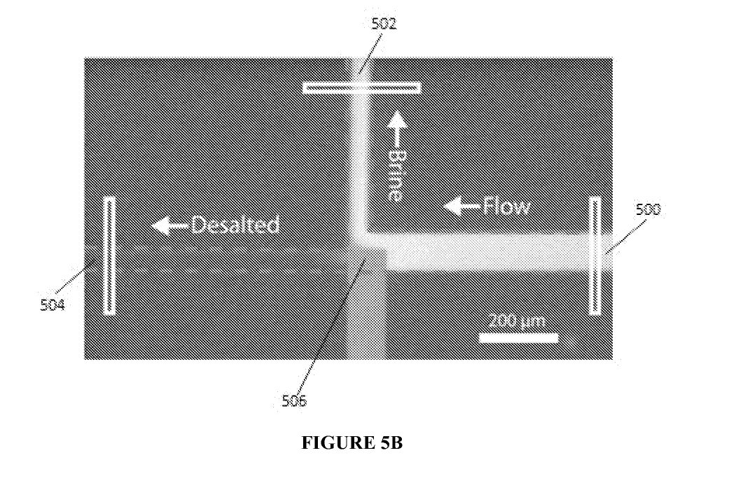

The flow of ionic species through the microchannels of the device was monitored by observing the flow of (BODIPY²⁻, a fluorescent anionic tracer) through the device. FIGS. 5A and 5B are fluorescence micrographs of the device taken before (FIG. 5A) and after (FIG. 5B) application of a 1.4 V potential bias. As shown in FIG. 5A, when no potential bias was applied, ions flow through the inlet channel (500), and into both the dilute outlet channel (504) and the concentrated outlet channel (502). Upon application of a potential bias, an ion depletion zone and subsequent electric field gradient are formed near the anode (506) in proximity to the intersection of the dilute outlet channel (504) and the concentrated outlet channel (502) (FIG. 5B). As a consequence, ions, including the fluorescent anionic tracer BODIPY²⁻, are directed into the concentrated outlet channel (502). Desalted water (which is non-fluorescent in the micrograph due to the absence of fluorescent anionic tracer BODIPY²⁻) flows into the dilute outlet channel (504). These results demonstrate that both cations and anions flow into the concentrated outlet channel. Note that some decrease in fluorescence intensity is due to bleaching of the BODIPY²⁻ tracer, but relative fluorescence intensities, representative of salt content in the inlet, brine, and dilute outlet streams supports that salts are redirected into the brine stream.

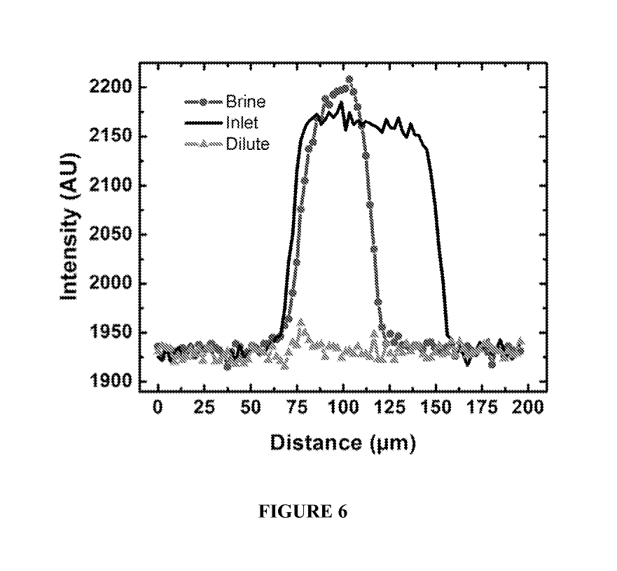

FIG. 6 depicts fluorescence line scans corresponding to the regions in FIG. 5B outlined with white boxes. Relative to the fluorescence intensity in the inlet, FIG. 6 shows a decrease in fluorescence intensity in the dilute outlet stream and an increase in the fluorescence intensity in the brine outlet stream consistent with desalination. All fluorescence intensities are plotted as arbitrary units versus distance (μm).

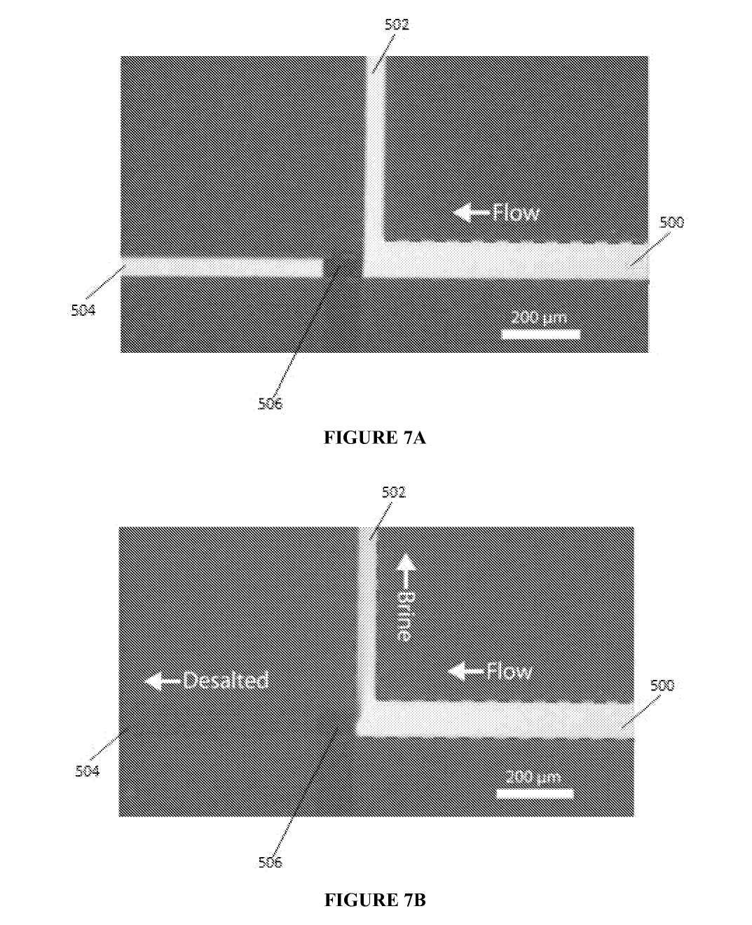

Similar results are presented in FIGS. 7A and 7B with the anode (506) located in a slightly different orientation relative to the bifurcated orthogonal channels. Depicted in FIG. 7A, when no potential bias was applied, ions flow through the inlet channel (500), and into both the dilute outlet channel (504) and the concentrated outlet channel (502). Upon application of a 1.4 V potential bias, an ion depletion zone and subsequent electric field gradient are formed near the anode (506) in proximity to the intersection of the dilute outlet channel (504) and the concentrated outlet channel (502) (FIG. 7B), thus causing ions and the fluorescent anionic tracer BODIPY²⁻ to be directed into the concentrated outlet channel (502).

### Example 2

### Design of First Generation Desalination Device

The first generation desalination device operates using a microelectrochemical process referred to as Electrochemically Mediated Seawater Desalination (EMD). The device includes a desalination member having a top surface and a bottom surface; a concentrated fluid chamber positioned in fluid contact with the top surface of the desalination member; a dilute fluid chamber positioned in fluid contact with the bottom surface of the desalination member; and a plurality of pores, each of which extends through the desalination member from an opening on the top surface of the desalination member to an opening on the bottom surface of the desalination member so as to fluidly connect the concentrated fluid chamber and the dilute fluid chamber. An electrode is positioned in electrochemical contact with each pore. The electrode elicits Faradaic chemical reactions, forming localized regions of ion depletion—and consequently electric field gradients—in proximity to the opening of each pore on the top surface of the desalination member. Upon a pressure driven flow of saltwater into the concentrated fluid chamber, the electric field gradients deflect charged species such as salts, viruses and bacteria away from the openings of the pores on the top surface of the desalination member, allowing desalted water to pass through the pores, and into the dilute fluid chamber. This process does not rely upon or use ion selective membranes to generate motivating fields of energy to induce desalination. The process thus obviates the need for an ionomer matrix or membrane, or other membrane surface that requires physical separation (e.g., filtration).

To facilitate initial investigation, the first generation desalination device was designed to be both modular and reusable. The device was also designed to possess simple inlet and outlet attachments, allow adjustable brine stream outlets, have simple 2-axis CNC milled components or off the shelf components, and be assembled without introducing outside chemicals (epoxies, etc.) that may contaminate the outlet streams. For purposes of initial investigation, the device was designed to incorporate a removable WaterChip (i.e., desalination member) which included a ˜1×1 cm square pore array.

WaterChip Fabrication

The WaterChip (i.e., desalination member) was fabricated from titanium foil. Titanium (Ti) is widely used by the chlorine industry, and is considered one of the most corrosion-resistant of the metals. When coated with anti-corrosive coatings, Ti electrodes are known to last for decades, even in caustic electrolytic solutions.

To form the WaterChip, the top and bottom surfaces of the titanium foil were first coated or covered with an insulating material. To accomplish this, the surfaces of the Ti foil were oxidized to form a non-conductive titanium oxide surface on the Ti foil. Subsequently, pores were formed through the Ti foil, exposing the unoxidized Ti foil in the interior, which can then function as an electrode in electrochemical contact with the pore.

Ti foils were oxidized using a Mighty Mite® tube furnace. In a proof-of-principle experiment, three Ti foil samples were cut into small pieces about 25 mm×25 mm. The Mighty Mite tube furnace was set to a set point (SP) of 850 degrees Celsius on the middle zone. There were no flow through gasses. The oxidation process took place in an ambient environment. Once the SP was reached, the first of the three samples (50 um thick) was placed into the middle zone of the furnace and allowed to dwell for 5 minutes then moved to an end zone and allowed to cool. The second sample (30 um thick) went through the same procedure, except the dwell time was 10 minutes. The third sample (50 um thick) was allowed to dwell for 15 minutes and then the SP was changed to 300 degrees Celsius with a ramp down of about 5 degrees per minute. This sample was allowed to cool to 390 degrees Celsius before it was moved to a cool zone and allowed to cool at room temperature.

ESEM (Scanning Electron Micrograph) images were taken using the FEI XL30 ESEM with samples placed on an edge. The thickness of the titanium oxide layers formed on the surfaces of the foil was measured. Oxide thicknesses were measured to be about 1 micron, 1.3 microns and 1.5 microns for each of the dwell times of 5, 10 and 15 minutes respectively. These measurements are within the range (1-5 microns) needed to insulate the interior Ti foil from the electrolytic media of seawater.

Subsequently, plasma etching was used to form pores within the oxidized Ti foil. 50 and 100 μm thick Ti foil samples (˜50 mm×50 mm square) were first oxidized as described above to from an oxide thickness of approximately 2.5 microns on the surfaces of the Ti foil. The oxidized samples were taped to a glass carrier with transfer silicone adhesive (3M 91022). MicroChem's KMPR negative photoresist was spin coated onto the sample to achieve a resist thickness of approximately 75 microns (1000 rpm, 40 seconds). The sample went through a soft-bake (SB) for 20 minutes at 100° C., exposed with a dot mask (to pattern 100 micron-diameter pores) for 255 seconds (−4.5-5 mJ/s), and post-exposure baked (PEB) for 4 minutes at 100° C. Finally, the sample was developed for 2 minutes in 2.38% TMAH aqueous solution in a sonicater and rinsed with DI water. The sample was removed from the glass carrier and adhered to a 6″ diameter Si wafer (resist side up) with 3M 8810 thermally conductive transfer tape.

The 6″ Si wafer with the samples was placed into the Plasma Therm Versaline ICP etcher. The plasma process was a multi-step process designed to process through the different layers of the foil forming the desalination member (i.e., TiO₂+Ti+TiO₂, where the TiO₂ layers utilized a different plasma than the bulk Ti). Plasma 1 (P1) was used to etch TiO₂ and had parameters set to 10 mTorr chamber pressure, 250W sample bias, 750W ICP power, 10 sccm Cl₂ flow plus 5 sccm Ar flow. Plasma 2 (P2) was used to etch the Ti interior, and had parameters set to 10 mTorr chamber pressure, 100W sample bias, 400W ICP power, 60 sccm C12 flow plus 5 sccm Ar flow. Every time a plasma was struck (P1 or P2), it was preceded by a Gas Flow step, and a Plasma Strike step to stabilized the plasma. These two different plasmas were combined into a single run with the following step sequence:
1) P1—29 minutes
2) 5 minute Timeout—to help cool the sample
3) P2—10 minutes
4) 5 minute Timeout
. . . Steps 3 and 4 were repeated 7 times for 50 micron foil, and 13 times for 100 micron foil
15) P1—29 minutes

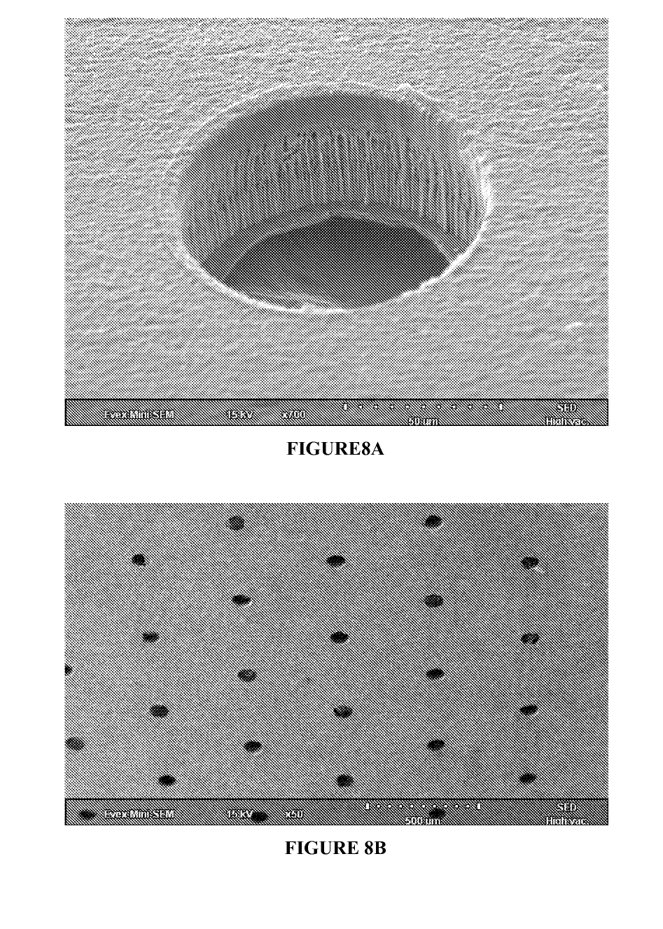

Pores were successfully etched through the foils. FIGS. 8A and 8B show SEM images of these resulting pores formed in the 50 micron foil.

Once the pores were successfully formed in the foil, the exposed, bare Ti within each pore (i.e., the Ti that forms a portion of the pore walls) can be treated to improve oxidation resistance. An anti-corrosive iridium oxide coating can be electro-deposited on the bare Ti surfaces to form a dimensionally stable metal oxide coating. Iridium oxide coated titanium electrodes are generally used in industry for chlorine generation, and are known to last for over 20 years based on a “paint and bake” deposition method.

The electro-deposition method can be demonstrated using bare Ti foil.

An electrodeposition solution was prepared by mixing 15 mg Anhydrous Iridium Tetrachloride (Alpha Aesar—56.5% mink) with 10 mL de-ionized (DI) water. After 10 minutes of mixing on an ATR Rotamixer, 0.1 mL 30% Hydrogen Peroxide (H₂O₂) was added. The solution was stirred for 5 minutes on an ATR Rotamixer. 50 mg Oxalic Acid was then added, and the solution was stirred for 20 minutes on an ATR Rotamixer. Potassium carbonate (K₂CO₃) was then added in small portions until the solution had a pH of 10.5. The solution was then allowed to incubate at room temperature from 3-7 days before electro-deposition.

50 micron thick bare Titanium foil was cut into strips. All samples were solvent cleaned (acetone, methanol, IPA) and allowed to dry for 2 minutes in a 100-120 degree Celsius oven. One sample had a Kapton tape backing deposition area, one sample had all sides exposed to the deposition solution, and a third sample was etched in sulfuric acid at 85 degrees Celsius for two minutes, this rinsed with water prior to being placed in the deposition beaker.

Simple electrodeposition involves a current source with two electrodes submerged in the iridium solution prepared above. One of the electrodes was the conductive sample to be coated (e.g., the Ti foil) while the other supplies the electrons (or metal ions) for coating. The Ti foil samples were affixed to the side wall of a beaker with copper tape, and attached to the positive electrode of a power supply (deposition anode). The deposition cathode was clipped onto a gold coated conductor salvaged from a coin cell battery holder.

Deposition current densities of between about 2-3 amps per square meter are suitable. The deposition areas were about 1-2 square centimeters, relating to 0.3-0.6 mA from the power supply. Since the power supply does not have a reading below 1 mA, the voltage was adjusted to the point where it read 1 mA (typically between 2-5V) and allowed to dwell for 10-15 minutes, based on the sample.

The Ti foil sample that was sulfuric etched prior to deposition showed a uniform IrO₂ film on both sides of the Ti foil. A multimeter resistance test read approximately 1-5 ohms between the bare titanium and the blue Iridium Oxide coating.

The deposition solution can be agitated during the process for a much more uniform coat. Post electro-deposition, the coating can be annealed (e.g., in a furnace at 500 degrees Celsius). Similar methods can be used to prepare titanium electrode coated with an iridium-tantalum oxide to get the longest (20-25 year) operating life. The mixed metal oxide can be deposited using a single electro-deposition step, or by alternating the deposition of iridium oxide and tantalum oxide layers (e.g., IrO₂, Ta₂O₅, IrO₂, Ta₂O₅, etc.). Once deposited, the coating can be annealed as described above.

Device Design and Assembly

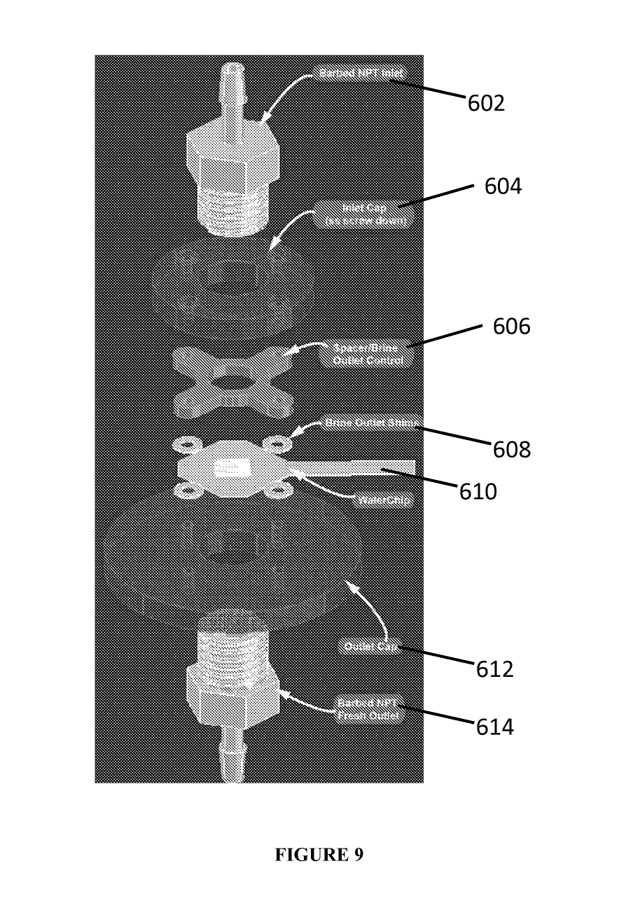

The first generation device is illustrated in FIG. 9. A 0.5″ ID national pipe thread (NPT) made of polypropylene with a barbed fitting to accept a 0.25″ tube served as the water inlet (602). This allowed incoming saltwater to flow normal to the pore opening s in the pore array (direct flow). If desired, the water inlet can be modified to include an inverted funnel or a Luer Lock connection. A ground can be easily introduced into the water inlet if desired, for example, by drilling a hole in the top of the NPT fitting, and inserting a platinum or ruthenium coated titanium group electrode.

The inlet cap (604) was threaded for the NPT fitting, and included thru-holes for four #4-40 stainless steel screws to provide for full assembly of the desalination device.

The inlet cap was laser milled with the Universal Laser System VLS3.50 out of 0.25″ thick clear acrylic. The spacer (606) also included screw thru-holes for alignment. When assembled, the inlet cap and spacer form a cavity (i.e., a concentrated fluid chamber) in fluid contact with the top surface of the desalination member (610). The bottom and outside edges of the spacer could also be coated with a grounding electrode (e.g., titanium+platinum or ruthenium). The spacer component was laser-milled out of 0.125″ clear acrylic.

Brine outlet shims (608) were included to allow for vertical adjustment at increments as small as 25 microns to balance the brine stream pressure for proper flow parameters. The brine outlet shims were fabricated from stainless steel.

The WaterChip (610) was placed centered onto the outlet cap (612) with silicone transfer tape. The WaterChip was configured to include a long, flat segment extending from one side of the chip to facilitate the +3V the electrical connection.

The outlet cap (612) was threaded for the same 0.5″ NPT threading for connecting another barbed fitting for back pressure and fresh water collection. The outlet cap included thru-holes for screws which were then terminated with nuts (e.g., thumb nuts). The outlet cap was laser-milled out of 0.25″ clear acrylic.

The fresh water outlet (614) was the same 0.5″ NPT fitting used for the water inlet. The fresh water outlet could include a ground connection, as described above with respect to the fluid inlet. The size of the outlet opening could be adjusted, as required, to change back pressure to ensure proper fluid flow through the device.

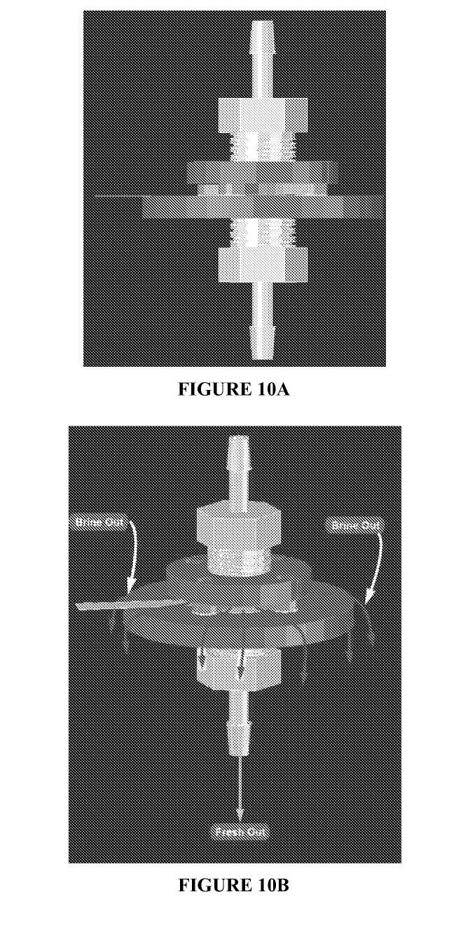

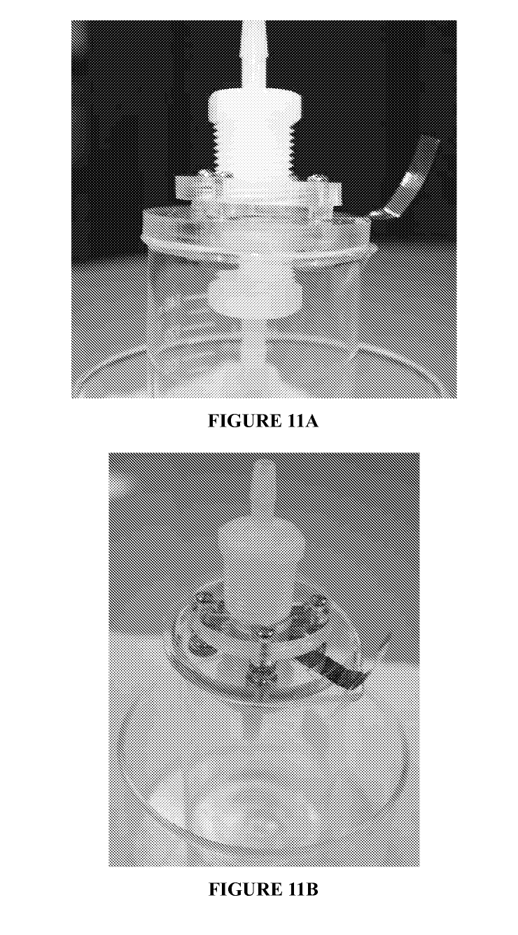

FIG. 10A shows a schematic side view of the assembled device for the desalination of water. FIG. 10B shows a schematic side view of the assembled device for the desalination of water, including arrows indicating the flow path of fluid from the concentrated fluid outlet(s) and dilute fluid outlet.

Photographs of the assembled device are shown in FIGS. 11A and 11B. For purposes of proof-of-principle tests, the separation of the outlet streams (brine and desalted water) can be accomplished by placing a smaller Griffin Beaker into a larger beaker or bowl. The smaller beaker is selected to have a small enough such that the outlet cap overhangs the lip of the beaker, allowing the small beaker to collect desalted water from the fresh water outlet, and the larger beaker or bowl to collect brine from the brine outlet streams. Desalination can be evaluated by measuring the conductivity of the fluids, or by monitoring the bleaching of a fluorescent tracer such fluorescein.

### Example 3

### Design of Second Generation Desalination Device

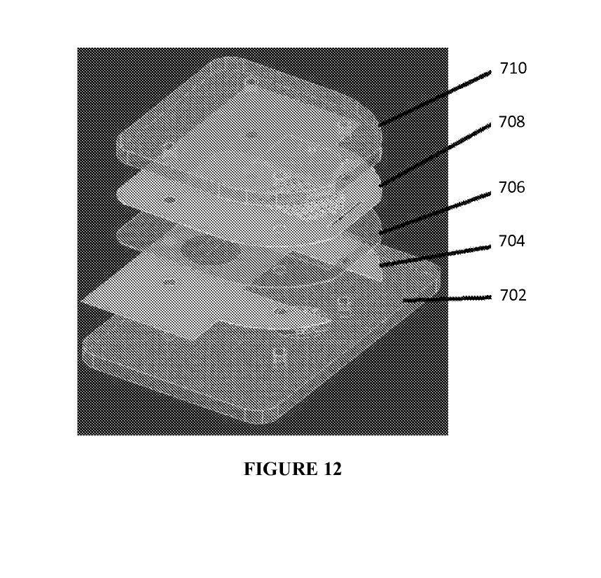

A second generation desalination device is illustrated in FIG. 12. The device includes five layers (from bottom to top in FIG. 12): a backing layer (702) including two fluid inlets for brine, a cathode layer (704) in electrochemical contact with the brine flowing into the fluid inlets, a spacer layer (706), an anode layer containing a WaterChip (not shown, inserted into the rectangular slot under 706), a second cathode layer (708), and a backing layer (710) containing a fresh water outlet and a brine outlet.

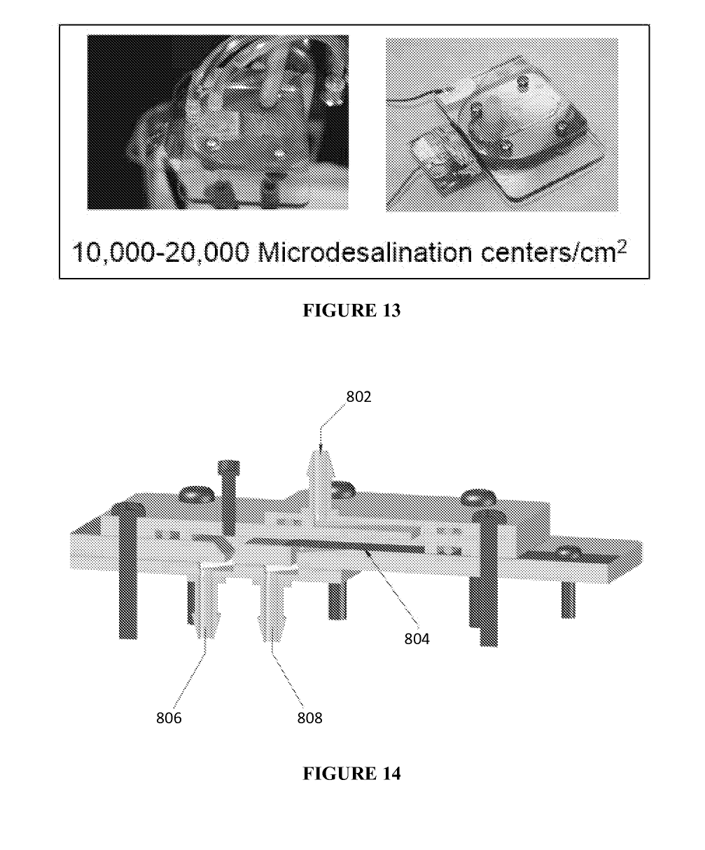

The second generation device can be fabricated using the methods described above with respect to the first generation device. The device includes two fluid inlets for brine, allowing for adjustment of feed water normal to the pore array in the anode layer as well as an initial horizontal laminar flow of feed water over top the pore array straight to the brine outlet. The device also includes a cathode (708) to drive rejected ions away from the anode layer towards the brine outlet. The spacer layer was configured to maintain a separation of less than about 1 mm between the cathode layer and the anode layer. FIG. 13 includes a photograph of the assembled device are shown in FIG. 12.

In a proof-of-principle test, brine containing 1 micromolar fluorescein was introduced into the two fluid inlets for brine. At 3.0 applied volts (current ˜1 milliamp), bleaching of the fluorescein was observed in the water flowing out of the brine outlets, suggesting chlorine oxidation was occurring at the anode, and that ions were being preferentially directed towards the brine outlets of the device. This finding was consistent with successful desalination of the brine water flowing through the device.

### Example 4

### Design of Third Generation Desalination Device

The WaterChip submodular cartridge illustrated in FIG. 14 was prepared and evaluated. The WaterChip submodular cartridge illustrated in FIG. 14 includes a cartridge housing, and a cathode plate with a taper relative to the electrode (anode) plate containing the micropores (804) contained within the cartridge housing. The micropore array was 1 cm² in area, containing about 20,000 pores, 25 μm in diameter each. In this example, no insulating layer was present on either the top or bottom of the electrode containing the pores, and the entire electrode, including the interior surface area of each pore was coated with a ruthenium/iridium mixture. The cartridge was placed in a test-bed system where seawater feedstock is fed to the cartridge through a fluid inlet (802) and both fresh water and brine discharged through separate brine outlets (806) and fresh water outlets (808). A side view of the example device is illustrated in FIG. 14.

In this example device, the feedstock is routed to one side of the WaterChip insert such that waters flow unidirectionally over the array of micropores embedded within the insert. The array shape in the WaterChip (electrode/anode insert) can be circular or rectangular, X rows by Y where X and Y represent any integer, with the cathode positioned above the WaterChip. The cathode was tapered (angled relative to the electrode/anode WaterChip insert with the pores), so that a constant water pressure, and thus constant water velocity should be observed at each row of pores in the array. That is, the cathode plate is designed slope down while the anode will not, creating a nozzle-like effect, elevating downstream pressure to be equivalent with upstream pressure. In essence, the titanium cathode acts as a microfluidic focusing plate as it gets closer to the anode as the water flows over the chip. In this design, the electrosmotic force increases from upstream to downstream portions of the anode.

Device Fabrication

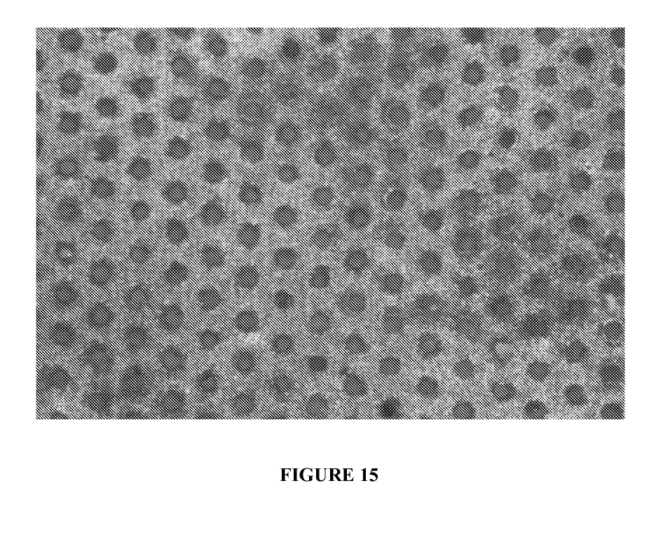

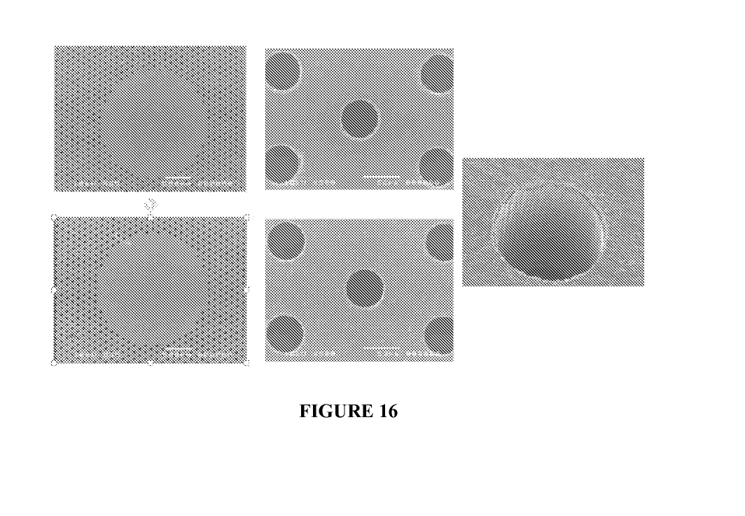

A piece of titanium foil between 0 and 200 μm in thickness (in this specific example the thickness was 50 μm) was laser ablated using either a nano-, pico-, or femtosecond laser to produce holes varying between 10 and 100 μm in diameter through the titanium foil (FIG. 15). Alternatively, the foil may be perforated by means of the TIDE plasma process or other such processes as are known in the art. An array of these holes was produced, distributed over a 1 cm×1 cm area, with the overall porosity (that is, reduction of the projected surface area) of this 1 cm×1 cm region being 10-50%. In this example the holes were 25 μm in diameter, on a 75-μm pitch, with triangular packing The titanium foil was coated with ruthenium, or alternatively a ruthenium-iridium mixture, by means of electroplating or thermally decomposition or other such methods as known in the art. This coating had a thickness between 200-5000 nm, whereby the thickness may be controlled by adjusting the application time and concentration of the solution. To obtain good adhesion and electrical contact, prior to coating, the foil was pre-treated by washing with 1% SDS solution, acetone, water, and then pickled in 12 N HCl at 95 degrees Celsius. A series of SEM micrographs showing the array of pores present in the resulting WaterChip are included in FIG. 16.

Flow plates were milled out of solid sheets of polymethylmethacrylate (PMMA) using microfabrication techniques known in the art. Both a top plate and a bottom plate were milled to provide gaps for microfluidic flow through the device as well as enabled the placement of electrodes into the middle of the cartridge. The device was sealed by PDMS gaskets tightened down by screws.

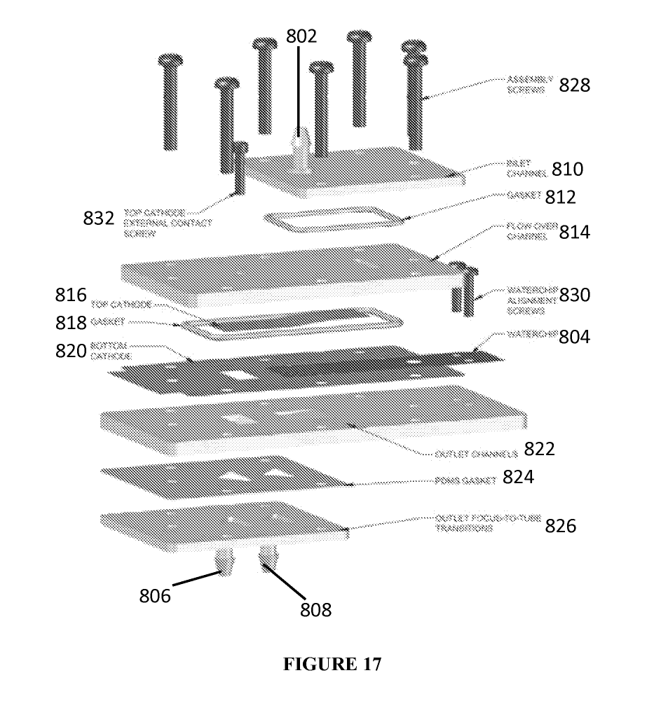

The over device design is illustrated the exploded view of the cartridge design shown in FIG. 17. As shown in FIG. 17, the device can be assembled from an inlet channel layer (810) containing a fluid inlet (802), a gasket (812), a flow over channel layer (814), a tapered top cathode (816), a gasket (818), a bottom cathode (820), the WaterChip (electrode/anode insert, 804), an outlet channel layer (822), a PDMS gasket (824), and an outlet focus-to-tube transition layer (826) connected to a brine outlet (806) and a fresh water outlet (808). Assembly screws (828) and alignment screws (830) can be used to assemble the device. Additional contact screws (832) can be used to facilitate electrical contact with electrode(s) in the device.

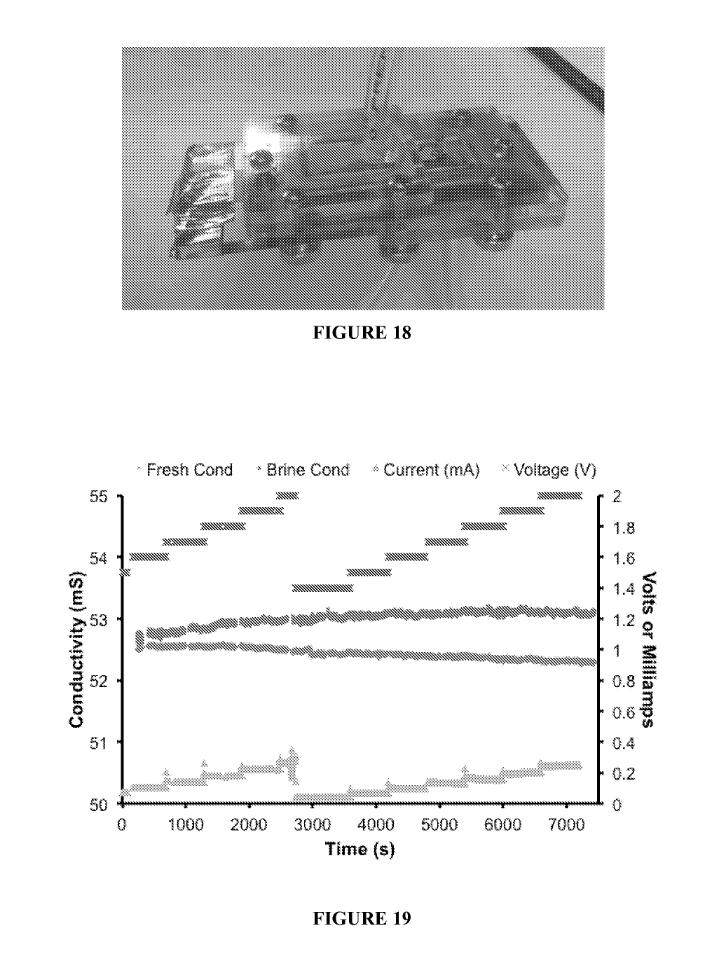

An assembled desalination cartridge had a single inlet (802) and two outlets, one for fresh water (808), and one for brine water (806). In the path of the fresh stream was placed a titanium anode assembly (804) comprising a 50-μm thick titanium sheet with a thin ruthenium-iridium coating, as described above. A top cathode (816), made of titanium or precious-metal-coated titanium, was placed directly above the anode (804), adhered to the surface of the PMMA top-plate (flow over channel layer, 814), but leaving a gap between the anode (804) and top cathode (816), through which fluid could flow. In this specific example, the gap varied linearly from 1000 μm to 500 μm from the inlet to the outlet. A bottom cathode (820), also made of titanium or precious-metal-coated titanium, in electrical contact with the top cathode (816), but electrically isolated from the anode (804), was placed around the anode. Below the anode, the flow plate (outlet channel layer, 822) was constructed so as to leave a gap under the anode through which fluid could flow. In this specific example the gap varied linearly from 0 μm at the inlet end to 500 μm at the outlet end. This arrangement provided within the cartridge an electrochemical cell with the anode positioned to divide the flow, with one portion of the flow proceeding through the anode and into the fresh outlet, and another portion of the flow proceeding between the anode and cathode, and into the brine outlet. Photographs of the assembled device are shown in FIG. 18.

Initial Evaluation of the Device

Application of a specific voltage that drives chlorine oxidation at the anode and water reduction at the cathode at any pH (in this example, at least 1.2 V and in the range of 1.2-2.0 V), and a matching pressure-driven flow (PDF) to provide the correct balance between electromigration forces generated between the anode and cathode and convection driven forces from microfluidic laminar flow, results in at least some desalination of the solution at the fresh outlet with enrichment of salt concentration of the solution at the brine outlet (i.e., lowered salt concentration in the fresh stream compared with the brine stream or the inlet concentration). The application of voltage is required, as the electric field gradient generated directed ions flowing through the channel inlet into a branching microchannel, creating a brine stream, while desalted water continued to flow forward through the microporous chip and into the fresh outlet.

A syringe pump was used to generate pressure-driven flow through the cartridge. The flow of water through both outlets was controlled both by the inlet pump (total flow rate) as well as by real-time monitoring of flow-rates in both outlets. When the two outlets diverged by greater than 10%, the valves were electronically adjusted in order to maintain the desired split in flow rate between the two outlets. In this example, the outlet flow rates were each maintained at 50% of the input flow rate.

Each outlet stream was monitored with flow-through conductivity meters using two electrodes coated with platinum black and with a constant current applied through the electrode. The flow-through conductivity meters were used to measure the resistivity of the solutions, and thus the salinity. The applied voltage was calibrated against salinity using known standards and measured using methods known to the art. Any bubbles generated by the electrochemical cell were removed by PTFE bubble traps before they could interfere with conductivity cell measurements.

A 1.4-2.0 V bias was applied in a step-wise fashion over increasing flow-rates (in this example at both 1 mL/min and 1.02 mL/min) using a power adapter between the anode and cathode pieces. It is contemplated that the potential bias created a sufficiently large potential difference between the anode and cathode to drive chloride oxidation at the anode, thus directly resulting in an ion depletion zone near the anode and creating an electrophoretic field that ran vertically between the anode and the cathode; in theory this resulted in sodium ions being preferentially concentrated between the anode and cathode, which were then convectively transferred towards the brine outlet instead of passing through the anode.

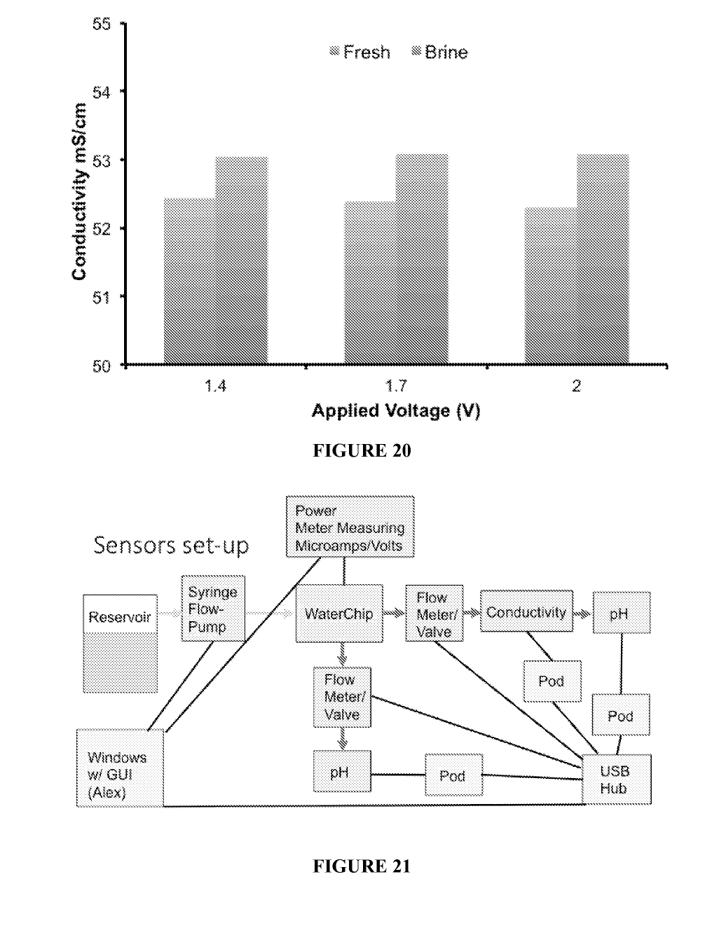

In this example, the feed solution was an artificial seawater solution comprising 500 mM NaCl, 10 mM sodium borate, buffered to pH 8.2. Desalination of this solution by approximately 1-2% was observed as a simultaneous increase in the conductivity in the brine outlet and the decrease in the fresh outlet (FIGS. 19 and 20). This change in conductivity was not observed without the application of voltage.

Note that in FIGS. 19 and 20, a time lag was observed due to the 2 mL volume capacity between the conductivity sensor and the cartridge. After applying the voltage and observing a decrease in the conductivity of the fresh stream, if the voltage was removed, the conductivity of the fresh stream again increases. Currents ranged from between 0.03 mA and 0.3 mA over the course of these experiments (with an apparent current density on the order of 0.1 mA/cm²). Higher current densities could achieve higher levels of desalination.

Further Proof-of-Principle Studies

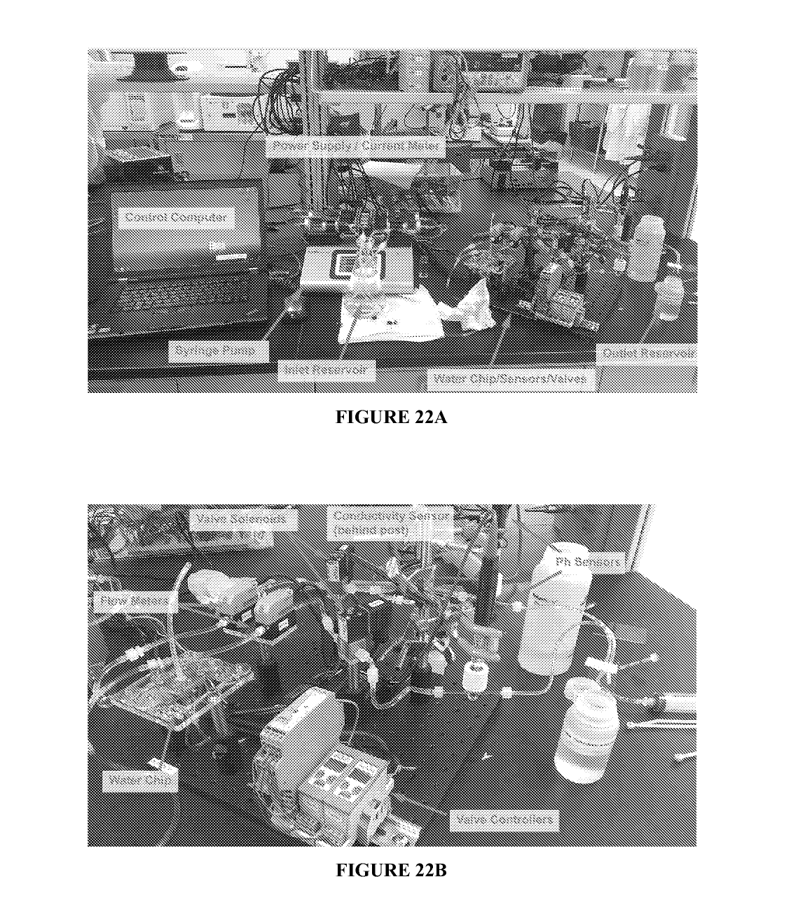

Desalination provided by the device was evaluated in detail within the context of a test-bed system as shown schematically in FIG. 21. FIGS. 22A and 22B are photographs of the actual system evaluated. Using a computer (CPU) and custom designed software application, variables for test runs, including the duration of the test run, the feedstock flow rates and/or changes in flow rates over time, and the voltage/current delivered to the WaterChip through connection points on the cartridge housing, were programmed. Various variables were measured in real time and stored in a database for analysis after the run, including pH of the brine discharge, pH of the fresh water discharge, conductivity of the brine discharge, conductivity of the fresh water discharge, temperature of the fresh water discharge, actual current and voltage delivered and actual flow rates for the brine and fresh water streams.

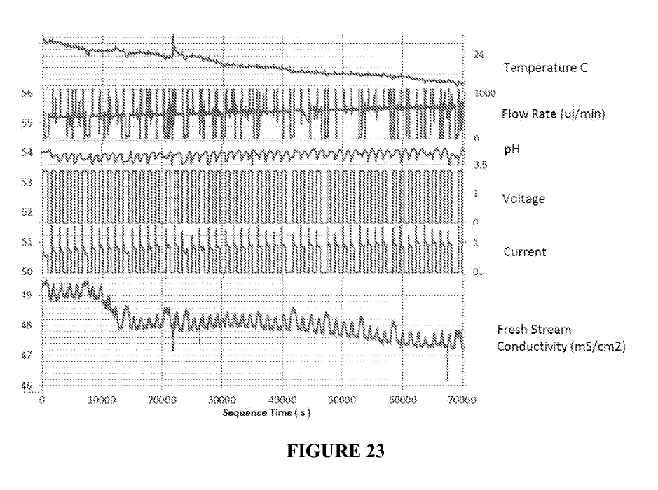

Using the test-bed system, numerous test runs incorporating various WaterChip inserts (e.g., having varied pore sizes, shapes, and layouts) were conducted. The various data collected was plotted with respect to time from the database file deposited by the test-bed setup. An example output is shown in FIG. 23 and discussed in detail below.

In this particular run, the pH cycles with voltage/current, an observation consistent with chloride oxidation to hypochlorous. As hypochlorous is formed at the pH seawater and below (chlorine is formed at higher pHs), the pH drops slightly because hypochlorous is an acid. The tight coupling between this pH cycling and the voltage/current indicates that chloride oxidation is taking place at the electrode/anode surface/seawater interface.

In this run, the fresh stream conductivity cycles with voltage/power. The observed conductivity changes were consistent with cyclical +/−1% desalination in response to power on/off cycling. This level of cycling is too great to be accounted for by the small (millimolar) levels of chloride being converted to hypochlorous by the electrode/anode. One millimolar of chloride being converted to hypochlorous would correspond to about a 0.2% desalination rate (0.001M/0.5M=0.2%, compared with the 1% observed here). In runs where no desalination was observed due to flow rate settings and imbalance between the electrochemistry and microfluidics, pH cycling was observed without fresh (or brine stream) conductivity cycling. Thus, the conductivity cycling shown in FIG. 23 is itself most likely indicative of desalination.

In addition, a large drop in fresh water conductivity was observed at approximately the 8,000 second mark in the run. At this point, the flow rates were matched with the power delivered to effect desalination of about 3.5%, increasing to about 5% by the end of the run at 70,000 seconds. The highest desalination rate (approximately 5%) was achieved at a flow rate of about 750 μL/min. The specific desalination energy consumption (efficiency) was approximately seven times the thermodynamic minima, encouraging given the fact that the entire electrode/anode surface was exposed to the seawater (not just the interior of the pores). These results support the conclusion that the disc based, pore design is capable of scaled EMD.

Control runs were conducted where the power supply was turned on but set to zero volts. In the beginning, before the run above was carried out, a correlation between temperature and baseline conductivity was observed. Accordingly a correction algorithm was developed to correct for temperature effects. The algorithm tends to overcompensate slightly, producing small conductivity rises with decreasing temperatures and small conductivity drops with increasing temperatures. In the example run shown in FIG. 23, no relationship was observed between temperature and fresh conductivity. In fact, temperature decreases during this run at times when the conductivity was relatively stable, and when temperatures continued to drop, the fresh stream conductivity did not increase (in fact, conductivity decreased further). Thus, the conductivity changes observed are not a temperature artifact. In fact, the observed 5% desalination may be an understatement given the slight decrease in temperature over the course of the run.

Additional evidence supports desalination, including the cycling of the fresh conductivity data with current as discussed above. In particular, the cycling effect is more pronounced (peaks reach higher heights) when zero volt intervals are the greatest (see, for example, the peaks at 20,000 s, 42,000 s and 58,000 s where the gap between 1.5V intervals is greatest). This latter point suggests this system has a certain amount of capacitance, and that it takes time for the desalination effect to be lost when power is cut off (e.g. the fresh water conductivity is in the process of climbing to its zero-desalination baseline at zero-volts, and this climb is interrupted by the application of power, and recommencement of desalination).

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods in addition to those shown and described herein are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A device comprising
(a) a desalination member having a top surface and a bottom surface;
(b) a concentrated fluid chamber positioned in fluid contact with the top surface of the desalination member;
(c) a dilute fluid chamber positioned in fluid contact with the bottom surface of the desalination member;
(d) a pore extending through the desalination member from an opening on the top surface of the desalination member to an opening on the bottom surface of the desalination member so as to fluidly connect the concentrated fluid chamber and the dilute fluid chamber; and
(e) an electrode in electrochemical contact with the concentrated fluid chamber, the pore, the dilute fluid chamber, or combinations thereof;
wherein the electrode is configured to generate an electric field gradient in proximity to the opening of the pore on the top surface of the desalination member.

2. The device of claim 1, wherein the electrode comprises an anode.

3. The device of claim 1, wherein the electrode comprises a cathode.

4. The device of claim 1, wherein the electrode is in electrochemical contact with the pore.

5. (canceled)

6. The device of claim 5, wherein the pore comprises a pore wall, and wherein the electrode forms at least a portion of the pore wall.

7. The device of claim 5, wherein the electrode forms at least about 50% of the pore wall, based on the total surface area of the pore wall.

8. The device of claim 1, wherein the desalination member comprises a conductive core layer having a top surface and a bottom surface, a first insulating layer disposed on the top surface of the conductive layer so as to form the top surface of the desalination member, and a second insulating layer disposed on the bottom surface of the conductive layer so as to form the bottom surface of the desalination member.

9. (canceled)

10. (canceled)

11. The device of claim 1, wherein the pore comprises a substantially circular horizontal cross-section, and wherein the pore has a diameter of from about 5 microns to about 1 mm.

12. (canceled)

13. (canceled)

14. (canceled)

15. (canceled)

16. The device of claim 1, further comprising an auxiliary channel fluidly isolated from the concentrated fluid chamber, the pore, and the dilute fluid chamber, and wherein the electrode comprises a bipolar electrode electrochemically connecting the concentrated fluid chamber, the pore, the dilute fluid chamber, or combinations thereof to the auxiliary channel.

17. (canceled)

18. The device of claim 1, wherein the pore is radially symmetrical about a central axis, and wherein the electrode is configured to generate an electric field gradient which is symmetrical about the central axis.

19. The device of claim 1, wherein the device comprises a plurality of pores, each of which extends through the desalination member from an opening on the top surface of the desalination member to an opening on the bottom surface of the desalination member so as to fluidly connect the concentrated fluid chamber and the dilute fluid chamber.

20. (canceled)

21. (canceled)

22. The device of claim 19, wherein the device comprises a pore density of from about 100 pores per cm² of desalination member to about 35,000 pores per cm² of desalination member.

23. The device of claim 19, wherein the electrode is configured to generate an electric field gradient in proximity to the opening of each of the plurality of pores on the top surface of the desalination member

24. The device of claim 19, wherein the device comprises a plurality of electrodes which in combination are configured to generate an electric field gradient in proximity to the opening of each of the plurality of pores on the top surface of the desalination member.

25. (canceled)

26. (canceled)

27. (canceled)

28. A module for decreasing the salinity of water comprising a plurality of devices defined by claim 1.

29. (canceled)

30. (canceled)

31. (canceled)

32. A water purification system comprising one or more of the modules defined by claim 28.

33. A method of decreasing the salinity of water comprising
(a) providing a flow of water having a first salinity into the concentrated fluid chamber of the device defined by claim 1;
(b) applying a potential bias to generate an electric field gradient that influences the flow of ions through the pore or the plurality of pores of the device defined by claim 1; and
(c) collecting water having a second salinity from the dilute fluid chamber of the device defined by claim 1;
wherein the second salinity is less than the first salinity.

34. (canceled)

35. (canceled)

36. (canceled)

37. The method of claim 33, wherein the electrical conductivity of the water having the second salinity does not exceed about 50% of the electrical conductivity of the water having the first salinity.

38. (canceled)

39. (canceled)

40. (canceled)

41. (canceled)

42. (canceled)

43. A method of decreasing the salinity of water comprising
(a) flowing water having a first salinity through a device comprising a desalination member having a top surface and a bottom surface; a concentrated fluid chamber positioned in fluid contact with the top surface of the desalination member; a dilute fluid chamber positioned in fluid contact with the bottom surface of the desalination member; and a pore extending through the desalination member from an opening on the top surface of the desalination member to an opening on the bottom surface of the desalination member so as to fluidly connect the concentrated fluid chamber and the dilute fluid chamber; and
(b) performing a faradaic reaction at an electrode in electrochemical contact with the concentrated fluid chamber, the pore, the dilute fluid chamber, or combinations thereof to generate an electric field gradient in proximity to the opening of the pore on the top surface of the desalination member;
wherein the electric field gradient directs ions in the water having a first salinity away from the opening of the pore on the top surface of the desalination member, allowing water having a second salinity less than the first salinity to pass through the pore and into the dilute fluid chamber.

44. The method of claim 43, wherein the pore is radially symmetrical about a central axis, and wherein the electrode is configured to generate an electric field gradient which is symmetrical about the central axis.
